(19) United States
(12) Patent Application Publication
(10) Pub. No.: US 2024/0340137 A1
(43) Pub. Date: Oct. 10, 2024

(54) POWER CONTROL ENHANCEMENT FOR SOUNDING REFERENCE SIGNAL TRANSMISSIONS

(71) Applicant: QUALCOMM Incorporated, San Diego, CA (US)

(72) Inventors: Yi HUANG, San Diego, CA (US); Xiao Feng WANG, San Diego, CA (US)

(21) Appl. No.: 18/608,725

(22) Filed: Mar. 18, 2024

Related U.S. Application Data
(60) Provisional application No. 63/494,734, filed on Apr. 6, 2023.

(51) Int. Cl. H04L 5/00; H04B 7/06; H04W 8/22; H04W 52/36; H04W 72/1268

(52) U.S. Cl. CPC H04L 5/0051; H04B 7/0626; H04L 5/0007; H04W 8/22; H04W 52/365; H04W 72/1268

(57) ABSTRACT

Aspects relate to a transmit power control for sounding reference signals (SRSs). In some aspects, the UE may receive an SRS configuration from a network entity, the SRS configuration indicating multiple SRS ports of an SRS resource assigned to multiple symbols. The UE may determine a port transmit power for each of the multiple SRS ports based on a total transmit power available for each of the multiple symbols divided by a number of the SRS ports assigned in each of the multiple symbols. The UE may then transmit, to the network entity, multiple SRSs respectively via the multiple SRS ports, wherein each SRS of the multiple SRSs is transmitted using the port transmit power via a respective SRS port of the multiple SRS ports in a respective symbol of the multiple symbols.

### PRIORITY CLAIM

This application claims priority to and the benefit of provisional patent application No. 63/494,734 filed in the United States Patent & Trademark Office on Apr. 6, 2023, the entire content of which is incorporated herein by reference as if fully set forth below in its entirety and for all applicable purposes

### TECHNICAL FIELD

The technology discussed below relates generally to wireless communication systems, and more particularly, to configuring transmit powers for sounding reference signals (SRSs).

### INTRODUCTION

Wireless communication systems, such as those specified under fifth generation (5G) systems, which may be referred to as New Radio (NR) systems, and sixth generation (6G) systems, may support a variety of use cases, including, for example, mobile broadband, metaverse, massive Internet of Things (IoT), sidelink, massive spectrum aggregation/duplex, and user equipment (UE) cooperation. In addition, these systems may support emerging technologies, such as full-duplex, radio frequency (RF) sensing, positioning, and physical (PHY) layer security.

In a wireless communication system, a network entity (e.g., a base station) may communicate with a UE (e.g., a smartphone). A UE may transmit a sounding reference signal (SRS), which is a reference signal transmitted to a network entity and may be used by the network entity to estimate the uplink channel quality. The SRS resources may be grouped in an SRS resource set. The SRS resource set may be periodic, aperiodic, or semi-persistent. The SRS resource sets may be for different usages, such as an antenna switching usage, a codebook-based usage, a non-codebook-based usage, or a beam management usage.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In one example, an apparatus for wireless communication at a user equipment (UE) is provided. The apparatus includes one or more memories and one or more processors coupled to the one or more memories. The one or more processors are configured to receive an SRS configuration from a network entity, the SRS configuration indicating a plurality of sounding reference signal (SRS) ports of an SRS resource assigned to a plurality of symbols; determine a port transmit power for each of the plurality of SRS ports based on a total transmit power available for each of the plurality of symbols divided by a number of the SRS ports assigned in each of the plurality of symbols; and transmit, to the network entity, a plurality of SRSs respectively via the plurality of SRS ports, wherein each SRS of the plurality of SRSs is transmitted using the port transmit power via a respective SRS port of the plurality of SRS ports in a respective symbol of the plurality of symbols.

Another example provides a method of wireless communication by a UE. The method includes receiving an SRS configuration from a network entity, the SRS configuration indicating a plurality of SRS ports of an SRS resource assigned to a plurality of symbols; determining a port transmit power for each of the plurality of SRS ports based on a total transmit power available for each of the plurality of symbols divided by a number of the SRS ports assigned in each of the plurality of symbols; and transmitting, to the network entity, a plurality of SRSs respectively via the plurality of SRS ports, wherein each SRS of the plurality of SRSs is transmitted using the port transmit power via a respective SRS port of the plurality of SRS ports in a respective symbol of the plurality of symbols.

Another example provides a UE including means for receiving an SRS configuration from a network entity, the SRS configuration indicating a plurality of SRS ports of an SRS resource assigned to a plurality of symbols; means for determining a port transmit power for each of the plurality of SRS ports based on a total transmit power available for each of the plurality of symbols divided by a number of the SRS ports assigned in each of the plurality of symbols; and means for transmitting, to the network entity, a plurality of SRSs respectively via the plurality of SRS ports, wherein each SRS of the plurality of SRSs is transmitted using the port transmit power via a respective SRS port of the plurality of SRS ports in a respective symbol of the plurality of symbols.

Another example provides a non-transitory computer-readable medium having stored therein instructions executable by one or more processors of a UE to cause the UE to: receive an SRS configuration from a network entity, the SRS configuration indicating a plurality of SRS ports of an SRS resource assigned to a plurality of symbols; determine a port transmit power for each of the plurality of SRS ports based on a total transmit power available for each of the plurality of symbols divided by a number of the SRS ports assigned in each of the plurality of symbols; and transmit, to the network entity, a plurality of SRSs respectively via the plurality of SRS ports, wherein each SRS of the plurality of SRSs is transmitted using the port transmit power via a respective SRS port of the plurality of SRS ports in a respective symbol of the plurality of symbols.

Another example provides an apparatus for wireless communication at a UE is provided. The apparatus includes one or more memories and one or more processors coupled to the one or more memories. The one or more processors are configured to receive an SRS configuration from a network entity, the SRS configuration indicating a plurality of SRS ports of an SRS resource assigned to a plurality of orthogonal frequency division multiplexing (OFDM) symbols; determine a plurality of maximum transmit powers respectively associated with the plurality of OFDM symbols, each of the plurality of maximum transmit powers being associated with a respective OFDM symbol of the plurality of OFDM symbol and being less than or equal to an maximum data transmit power available for transmitting uplink data using the plurality of SRS ports simultaneously; and transmit, to the network entity, a plurality of SRSs respectively via the plurality of SRS ports in the plurality of OFDM symbols, wherein in each OFDM symbol, one or more SRSs of the plurality of SRSs are transmitted respectively via one or more ports of the plurality of SRS ports assigned to a respective OFDM symbol of the plurality of OFDM symbols, the one or more SRSs being transmitted using a respective maximum transmit power of the plurality of maximum transmit powers that is associated with the respective OFDM symbol.

Another example provides a method of wireless communication by a UE. The method includes receiving an SRS configuration from a network entity, the SRS configuration indicating a plurality of SRS ports of an SRS resource assigned to a plurality of OFDM symbols; determining a plurality of maximum transmit powers respectively associated with the plurality of OFDM symbols, each of the plurality of maximum transmit powers being associated with a respective OFDM symbol of the plurality of OFDM symbol and being less than or equal to an maximum data transmit power available for transmitting uplink data using the plurality of SRS ports simultaneously; and transmitting, to the network entity, a plurality of SRSs respectively via the plurality of SRS ports in the plurality of OFDM symbols, wherein in each OFDM symbol, one or more SRSs of the plurality of SRSs are transmitted respectively via one or more ports of the plurality of SRS ports assigned to a respective OFDM symbol of the plurality of OFDM symbols, the one or more SRSs being transmitted using a respective maximum transmit power of the plurality of maximum transmit powers that is associated with the respective OFDM symbol.

Another example provides a UE including means for receiving an SRS configuration from a network entity, the SRS configuration indicating a plurality of SRS ports of an SRS resource assigned to a plurality of OFDM symbols; means for determining a plurality of maximum transmit powers respectively associated with the plurality of OFDM symbols, each of the plurality of maximum transmit powers being associated with a respective OFDM symbol of the plurality of OFDM symbol and being less than or equal to an maximum data transmit power available for transmitting uplink data using the plurality of SRS ports simultaneously; and means for transmitting, to the network entity, a plurality of SRSs respectively via the plurality of SRS ports in the plurality of OFDM symbols, wherein in each OFDM symbol, one or more SRSs of the plurality of SRSs are transmitted respectively via one or more ports of the plurality of SRS ports assigned to a respective OFDM symbol of the plurality of OFDM symbols, the one or more SRSs being transmitted using a respective maximum transmit power of the plurality of maximum transmit powers that is associated with the respective OFDM symbol.

Another example provides a non-transitory computer-readable medium having stored therein instructions executable by one or more processors of a UE to cause the UE to: receive an SRS configuration from a network entity, the SRS configuration indicating a plurality of SRS ports of an SRS resource assigned to a plurality of OFDM symbols; determine a plurality of maximum transmit powers respectively associated with the plurality of OFDM symbols, each of the plurality of maximum transmit powers being associated with a respective OFDM symbol of the plurality of OFDM symbol and being less than or equal to an maximum data transmit power available for transmitting uplink data using the plurality of SRS ports simultaneously; and transmit, to the network entity, a plurality of SRSs respectively via the plurality of SRS ports in the plurality of OFDM symbols, wherein in each OFDM symbol, one or more SRSs of the plurality of SRSs are transmitted respectively via one or more ports of the plurality of SRS ports assigned to a respective OFDM symbol of the plurality of OFDM symbols, the one or more SRSs being transmitted using a respective maximum transmit power of the plurality of maximum transmit powers that is associated with the respective OFDM symbol.

Another example provides an apparatus for wireless communication at a network entity. The apparatus includes one or more memories and one or more processors coupled to the one or more memories. The one or more processors are configured to transmit an SRS configuration to a UE, the SRS configuration indicating a plurality of SRS ports of an SRS resource assigned to a plurality of symbols, wherein a port transmit power for each of the plurality of SRS ports is based on a total transmit power divided by a number of the SRS ports assigned in each of the plurality of symbols; obtain, from the UE, a plurality of SRSs respectively via the plurality of SRS ports, wherein each SRS of the plurality of SRSs is obtained via a respective SRS port of the plurality of SRS ports in a respective symbol of the plurality of symbols using the port transmit power; and estimate a plurality of uplink channel qualities respectively associated with the plurality of SRS ports based on the plurality of SRSs.

Another example provides a method of wireless communication by a network entity. The method includes transmitting an SRS configuration to a UE, the SRS configuration indicating a plurality of SRS ports of an SRS resource assigned to a plurality of symbols, wherein a port transmit power for each of the plurality of SRS ports is based on a total transmit power divided by a number of the SRS ports assigned in each of the plurality of symbols; obtaining, from the UE, a plurality of SRSs respectively via the plurality of SRS ports, wherein each SRS of the plurality of SRSs is obtained via a respective SRS port of the plurality of SRS ports in a respective symbol of the plurality of symbols using the port transmit power; and estimating a plurality of uplink channel qualities respectively associated with the plurality of SRS ports based on the plurality of SRSs.

Another example provides a network entity including means for transmitting an SRS configuration to a UE, the SRS configuration indicating a plurality of SRS ports of an SRS resource assigned to a plurality of symbols, wherein a port transmit power for each of the plurality of SRS ports is based on a total transmit power divided by a number of the SRS ports assigned in each of the plurality of symbols; means for obtaining, from the UE, a plurality of SRSs respectively via the plurality of SRS ports, wherein each SRS of the plurality of SRSs is obtained via a respective SRS port of the plurality of SRS ports in a respective symbol of the plurality of symbols using the port transmit power; and means for estimating a plurality of uplink channel qualities respectively associated with the plurality of SRS ports based on the plurality of SRSs.

Another example provides a non-transitory computer-readable medium having stored therein instructions executable by one or more processors of a network entity to cause the network entity to: transmit an SRS configuration to a UE, the SRS configuration indicating a plurality of SRS ports of an SRS resource assigned to a plurality of symbols, wherein a port transmit power for each of the plurality of SRS ports is based on a total transmit power divided by a number of the SRS ports assigned in each of the plurality of symbols; obtain, from the UE, a plurality of SRSs respectively via the plurality of SRS ports, wherein each SRS of the plurality of SRSs is obtained via a respective SRS port of the plurality of SRS ports in a respective symbol of the plurality of symbols using the port transmit power; and estimate a plurality of uplink channel qualities respectively associated with the plurality of SRS ports based on the plurality of SRSs.

Another example provides an apparatus for wireless communication at a network entity. The apparatus includes one or more memories and one or more processors coupled to the one or more memories. The one or more processors are configured to transmit an SRS configuration to a UE, the SRS configuration indicating a plurality of SRS ports of an SRS resource assigned to a plurality of OFDM symbols, wherein a plurality of maximum transmit powers are respectively associated with the plurality of OFDM symbols, and wherein each of the plurality of maximum transmit powers is associated with a respective OFDM symbol of the plurality of OFDM symbols and is less than or equal to an maximum data transmit power available for transmitting uplink data using the plurality of SRS ports simultaneously; obtain, from the UE, a plurality of SRSs respectively via the plurality of SRS ports in the plurality of OFDM symbols, wherein in each OFDM symbol, one or more SRSs of the plurality of SRSs are obtained respectively via one or more SRS ports of the plurality of SRS ports assigned to a respective OFDM symbol of the plurality of OFDM symbols, the one or more SRSs being obtained using a respective maximum transmit power of the plurality of maximum transmit powers that is associated with the respective OFDM symbol; and estimate a plurality of uplink channel qualities respectively associated with the plurality of SRS ports based on the plurality of SRSs.

Another example provides a method of wireless communication by a network entity. The method includes transmitting an SRS configuration to a UE, the SRS configuration indicating a plurality of SRS ports of an SRS resource assigned to a plurality of OFDM symbols, wherein a plurality of maximum transmit powers are respectively associated with the plurality of OFDM symbols, and wherein each of the plurality of maximum transmit powers is associated with a respective OFDM symbol of the plurality of OFDM symbols and is less than or equal to an maximum data transmit power available for transmitting uplink data using the plurality of SRS ports simultaneously; obtaining, from the UE, a plurality of SRSs respectively via the plurality of SRS ports in the plurality of OFDM symbols, wherein in each OFDM symbol, one or more SRSs of the plurality of SRSs are obtained respectively via one or more SRS ports of the plurality of SRS ports assigned to a respective OFDM symbol of the plurality of OFDM symbols, the one or more SRSs being obtained using a respective maximum transmit power of the plurality of maximum transmit powers that is associated with the respective OFDM symbol; and estimating a plurality of uplink channel qualities respectively associated with the plurality of SRS ports based on the plurality of SRSs.

Another example provides a network entity including means for transmitting an SRS configuration to a UE, the SRS configuration indicating a plurality of SRS ports of an SRS resource assigned to a plurality of OFDM symbols, wherein a plurality of maximum transmit powers are respectively associated with the plurality of OFDM symbols, and wherein each of the plurality of maximum transmit powers is associated with a respective OFDM symbol of the plurality of OFDM symbols and is less than or equal to an maximum data transmit power available for transmitting uplink data using the plurality of SRS ports simultaneously; means for obtaining, from the UE, a plurality of SRSs respectively via the plurality of SRS ports in the plurality of OFDM symbols, wherein in each OFDM symbol, one or more SRSs of the plurality of SRSs are obtained respectively via one or more SRS ports of the plurality of SRS ports assigned to a respective OFDM symbol of the plurality of OFDM symbols, the one or more SRSs being obtained using a respective maximum transmit power of the plurality of maximum transmit powers that is associated with the respective OFDM symbol; and means for estimating a plurality of uplink channel qualities respectively associated with the plurality of SRS ports based on the plurality of SRSs.

Another example provides a non-transitory computer-readable medium having stored therein instructions executable by one or more processors of a network entity to cause the network entity to: transmit an SRS configuration to a UE, the SRS configuration indicating a plurality of SRS ports of an SRS resource assigned to a plurality of OFDM symbols, wherein a plurality of maximum transmit powers are respectively associated with the plurality of OFDM symbols, and wherein each of the plurality of maximum transmit powers is associated with a respective OFDM symbol of the plurality of OFDM symbols and is less than or equal to an maximum data transmit power available for transmitting uplink data using the plurality of SRS ports simultaneously; obtain, from the UE, a plurality of SRSs respectively via the plurality of SRS ports in the plurality of OFDM symbols, wherein in each OFDM symbol, one or more SRSs of the plurality of SRSs are obtained respectively via one or more SRS ports of the plurality of SRS ports assigned to a respective OFDM symbol of the plurality of OFDM symbols, the one or more SRSs being obtained using a respective maximum transmit power of the plurality of maximum transmit powers that is associated with the respective OFDM symbol; and estimate a plurality of uplink channel qualities respectively associated with the plurality of SRS ports based on the plurality of SRSs.

These and other aspects will become more fully understood upon a review of the detailed description, which follows. Other aspects, features, and examples will become apparent to those of ordinary skill in the art upon reviewing the following description of specific exemplary aspects in conjunction with the accompanying figures. While features may be discussed relative to certain examples and figures below, all examples can include one or more of the features discussed herein. In other words, while one or more examples may be discussed as having certain features, one or more of such features may also be used in accordance with the various examples discussed herein. Similarly, while examples may be discussed below as device, system, or method examples, it should be understood that such examples can be implemented in various devices, systems, and methods.

### BRIEF DESCRIPTION OF THE DRAWINGS

FIG. 1 is a diagram illustrating an example of a wireless communication system according to some aspects.

FIG. 2 is a diagram providing a high-level illustration of one example of a configuration of a disaggregated base station according to some aspects.

FIG. 3 is a schematic illustration of an organization of wireless resources in an air interface utilizing orthogonal frequency divisional multiplexing (OFDM) according to some aspects.

FIG. 4 is a diagram illustrating an example of communication between a base station and a UE using beamforming according to some aspects.

FIG. 5 is a diagram illustrating exemplary sounding reference signal (SRS) configurations for SRS resource sets, each including SRS resources according to some aspects.

FIG. 6 is an example diagram illustrating different SRS resource sets for different usages.

FIG. 7 is an example diagram illustrating SRS transmissions using 8 ports within a single OFDM symbol.

FIG. 8 is an example diagram illustrating features performed by a UE and a network entity, according to some aspects.

FIG. 9 is an example diagram illustrating multiple ports of a UE assigned to multiple resources, according to some aspects.

FIGS. 10A and 10B are example diagrams illustrating maximum transmit powers respectively for multiple OFDM symbols, according to some aspects.

FIGS. 11A and 11B are example diagrams illustrating maximum transmit powers respectively for multiple OFDM symbols, where at least one of the maximum transmit powers is different from another maximum transmit power, according to some aspects.

FIGS. 12A and 12B are example diagrams illustrating maximum transmit powers respectively for multiple OFDM symbols, where all of the OFDM symbols are coherent with each other, according to some aspects.

FIGS. 13A and 13B are example diagrams illustrating maximum transmit powers respectively for multiple OFDM symbols, where two subsets of OFDM symbols are not coherent with each other, according to some aspects.

FIG. 14 is a block diagram illustrating an example of a hardware implementation for a UE 1400 employing a processing system, according to some aspects.

FIG. 15 is a flow chart illustrating an exemplary process for wireless communication by a user equipment (UE) in accordance with some aspects.

FIG. 16 is a flow chart illustrating an exemplary process for wireless communication by a UE in accordance with some aspects.

FIG. 17 is a conceptual diagram illustrating an example of a hardware implementation for an exemplary network entity employing a processing system, according to some aspects.

FIG. 18 is a flow chart illustrating an exemplary process for wireless communication by a network entity in accordance with some aspects.

FIG. 19 is a flow chart illustrating an exemplary process for wireless communication by a network entity in accordance with some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip examples and other non-module-component-based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for the implementation and practice of claimed and described examples. For example, transmission and reception of wireless signals necessarily includes a number of components for analog and digital purposes (e.g., hardware components including antenna, radio frequency (RF) chains (RF-chains), power amplifiers, modulators, buffer, processor(s), interleaver, adders/summers, etc.). It is intended that innovations described herein may be practiced in a wide variety of devices, chip-level components, systems, distributed arrangements, disaggregated arrangements (e.g., network entity and/or UE), end-user devices, etc., of varying sizes, shapes, and constitution.

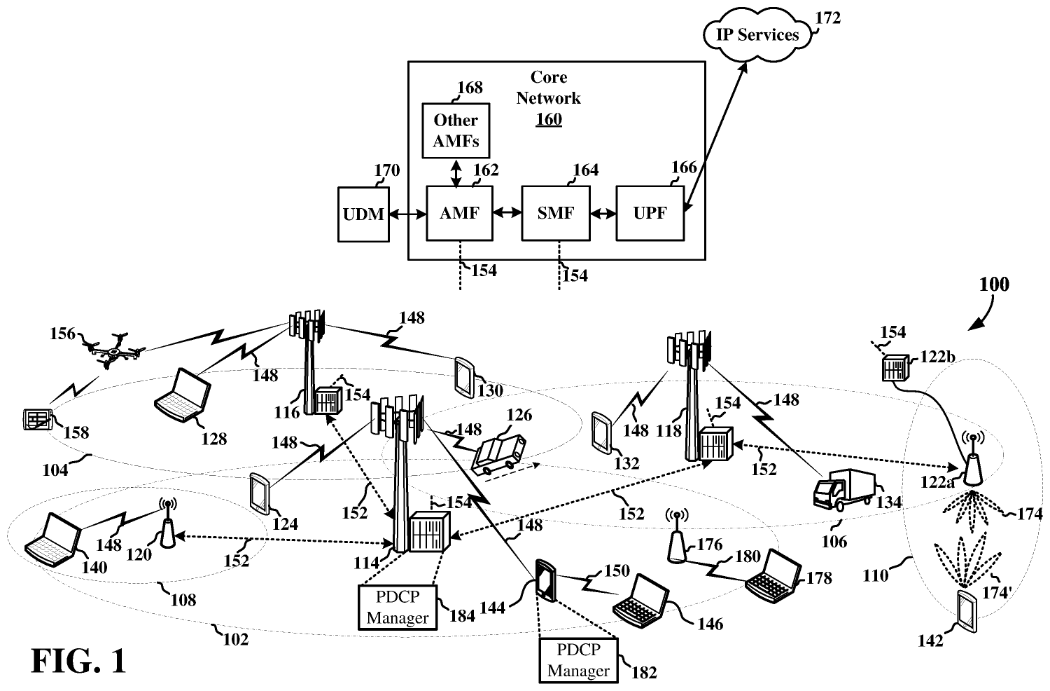

The various concepts presented throughout this disclosure may be implemented across a broad variety of telecommunication systems, network architectures, and communication standards. Referring now to FIG. 1, as an illustrative example without limitation, a schematic illustration of a wireless communication network including a radio access network (RAN) 100 and a core network 160 is provided. The RAN 100 may implement any suitable wireless communication technology or technologies to provide radio access. As one example, the RAN 100 may operate according to 3^{rd} Generation Partnership Project (3GPP) New Radio (NR) specifications, often referred to as 5G. As another example, the RAN 100 may operate under a hybrid of 5G NR and Evolved Universal Terrestrial Radio Access Network (cUTRAN) standards, often referred to as LTE. The 3GPP refers to this hybrid RAN as a next-generation RAN, or NG-RAN. In other examples, the RAN 100 may operate according to a hybrid of 5G NR and 6G, may operate according to 6G, or may operate according to other future radio access technology (RAT). Of course, many other examples may be utilized within the scope of the present disclosure.

The geographic region covered by the RAN 100 may be divided into a number of cellular regions (cells) that can be uniquely identified by a user equipment (UE) based on an identification broadcasted over a geographical area from one access point or network entity. FIG. 1 illustrates cells 102, 104, 106, 108, and 110 each of which may include one or more sectors (not shown). A sector is a sub-area of a cell. All sectors within one cell are served by the same network entity. A radio link within a sector can be identified by a single logical identification belonging to that sector. In a cell that is divided into sectors, the multiple sectors within a cell can be formed by groups of antennas with each antenna responsible for communication with UEs in a portion of the cell.

In general, a respective network entity serves each cell. Broadly, a network entity is responsible for radio transmission and reception in one or more cells to or from a UE. A network entity may also be referred to by those skilled in the art as a base station (e.g., an aggregated base station or disaggregated base station), base transceiver station (BTS), a radio base station, a radio transceiver, a transceiver function, a basic service set (BSS), an extended service set (ESS), an access point (AP), a Node B (NB), an evolved NB (cNB), a 5G NB (gNB), a transmission receive point (TRP), or some other suitable terminology. In some examples, a network entity may include two or more TRPs that may be collocated or non-collocated. Each TRP may communicate on the same or different carrier frequency within the same or different frequency band. In examples where the RAN 100 operates according to both the LTE and 5G NR standards, one of the network entities may be an LTE network entity, while another network entity may be a 5G NR network entity.

In some examples, the RAN 100 may employ an open RAN (O-RAN) to provide a standardization of radio interfaces to procure interoperability between component radio equipment. For example, in an O-RAN, the RAN may be disaggregated into a centralized unit (CU), a distributed unit (DU), and a radio unit (RU). The RU is configured to transmit and/or receive (RF) signals to and/or from one or more UEs. The RU may be located at, near, or integrated with, an antenna. The DU and the CU provide computational functions and may facilitate the transmission of digitized radio signals within the RAN 100. In some examples, the DU may be physically located at or near the RU. In some examples, the CU may be located near the core network 160.

The DU provides downlink and uplink baseband processing, a supply system synchronization clock, signal processing, and an interface with the CU. The RU provides downlink baseband signal conversion to an RF signal, and uplink RF signal conversion to a baseband signal. The O-RAN may include an open fronthaul (FH) interface between the DU and the RU. Aspects of the disclosure may be applicable to an aggregated RAN and/or to a disaggregated RAN (e.g., an O-RAN).

Various network entity arrangements can be utilized. For example, in FIG. 1, network entities 114, 116, and 118 are shown in cells 102, 104, and 106; and another network entity 122 is shown controlling a remote radio head (RRH) 122 in cell 110. That is, a network entity can have an integrated antenna or can be connected to an antenna or RRH by feeder cables. In the illustrated example, the cells 102, 104, 106, and 110 may be referred to as macrocells, as the network entities 114, 116, 118, and 122 support cells having a large size. Further, a network entity 120 is shown in the cell 108 which may overlap with one or more macrocells. In this example, the cell 108 may be referred to as a small cell (e.g., a microcell, picocell, femtocell, home base station, home Node B, home eNode B, etc.), as the network entity 120 supports a cell having a relatively small size. Cell sizing can be done according to system design as well as component constraints.

It is to be understood that the RAN 100 may include any number of network entities and cells. Further, a relay node may be deployed to extend the size or coverage area of a given cell. In some examples, a cell may not necessarily be stationary, and the geographic area of the cell may move according to the location of a mobile network entity.

FIG. 1 further includes an unmanned aerial vehicle (UAV) 156, which may be a drone or quadcopter. The UAV 156 may be configured to function as a network entity, or more specifically as a mobile network entity. That is, in some examples, a cell may not necessarily be stationary, and the geographic area of the cell may move according to the location of a mobile network entity such as the UAV 156.

In addition to other functions, the network entities 114, 116, 118, 120, and 122a/122b may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The network entities 114, 116, 118, 120, and 122a/122b may communicate directly or indirectly (e.g., through the core network 170) with each other over backhaul links 152 (e.g., X2 interface). The backhaul links 152 may be wired or wireless.

The RAN 100 is illustrated supporting wireless communication for multiple mobile apparatuses. A mobile apparatus is commonly referred to as user equipment (UE) in standards and specifications promulgated by the 3rd Generation Partnership Project (3GPP), but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus that provides a user with access to network services.

Within the present document, a “mobile” apparatus need not necessarily have a capability to move, and may be stationary. The term mobile apparatus or mobile device broadly refers to a diverse array of devices and technologies. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, agricultural equipment, etc. Still further, a mobile apparatus may provide for connected medicine or telemedicine support, i.e., health care at a distance. Telehealth devices may include telehealth monitoring devices and telehealth administration devices, whose communication may be prioritized access over other types of information, e.g., in terms of prioritized access for transport of critical service data, and/or relevant QoS for transport of critical service data.

Within the RAN 100, the cells may include UEs that may be in communication with one or more sectors of each cell. For example, UEs 124, 126, and 144 may be in communication with network entity 114; UEs 128 and 130 may be in communication with network entity 116; UEs 132 and 138 may be in communication with network entity 118; UE 140 may be in communication with network entity 120; UE 142 may be in communication with network entity 122a via RRH 122b; and UE 158 may be in communication with mobile network entity 156. Here, each network entity 114, 116, 118, 120, 122a/122b, and 156 may be configured to provide an access point to the core network 170 (not shown) for all the UEs in the respective cells. In another example, a mobile network node (e.g., UAV 156) may be configured to function as a UE. For example, the UAV 156 may operate within cell 104 by communicating with network entity 116. UEs may be located anywhere within a serving cell. UEs that are located closer to a center of a cell (e.g., UE 132) may be referred to as cell center UEs, whereas UEs that are located closer to an edge of a cell (e.g., UE 134) may be referred to as cell edge UEs. Cell center UEs may have a higher signal quality (e.g., a higher reference signal received power (RSRP) or signal-to interference-plus-noise ratio (SINR)) than cell edge UEs.

In the RAN 100, the ability for a UE to communicate while moving, independent of their location, is referred to as mobility. The various physical channels between the UE and the RAN are generally set up, maintained, and released under the control of an access and mobility management function (AMF), which may include a security context management function (SCMF) that manages the security context for both the control plane and the user plane functionality and a security anchor function (SEAF) that performs authentication. In some examples, during a call facilitated by a network entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE May undertake a handoff or handover from the serving cell to the neighboring (target) cell. For example, UE 126 may move from the geographic area corresponding to its serving cell 102 to the geographic area corresponding to a neighbor cell 106. When the signal strength or quality from the neighbor cell 106 exceeds that of its serving cell 102 for a given amount of time, the UE 126 may transmit a reporting message to its serving network entity 114 indicating this condition. In response, the UE 126 may receive a handover command, and the UE may undergo a handover to the cell 106.

Wireless communication between a RAN 100 and a UE (e.g., UE 124, 126, or 144) may be described as utilizing communication links 148 over an air interface. Transmissions over the communication links 148 between the network entities and the UEs may include uplink (UL) (also referred to as reverse link) transmissions from a UE to a network entity and/or downlink (DL) (also referred to as forward link) transmissions from a network entity to a UE. For example, DL transmissions may include unicast or broadcast transmissions of control information and/or data (e.g., user data traffic or other type of traffic) from a network entity (e.g., network entity 114) to one or more UEs (e.g., UEs 124, 126, and 144), while UL transmissions may include transmissions of control information and/or traffic information originating at a UE (e.g., UE 124). In addition, the uplink and/or downlink control information and/or traffic information may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols. A subframe may refer to a duration of 1 ms. Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

The communication links 148 may use multiple-input and multiple-output (MIMO) antenna technology, including spatial multiplexing, beamforming, and/or transmit diversity. For example, as shown in FIG. 1, network entity 122a/122b may transmit a beamformed signal to the UE 142 via one or more beams 174 in one or more transmit directions. The UE 142 may further receive the beamformed signal from the network entity 122a/122b via one or more beams 174′ in one or more receive directions. The UE 142 may also transmit a beamformed signal to the network entity 122a/122b via the one or more beams 174′ in one or more transmit directions. The network entity 122a/122b may further receive the beamformed signal from the UE 142 via the one or more beams 174 in one or more receive directions. The network entity 122a/122b and the UE 142 may perform beam training to determine the best transmit and receive beams 174/174′ for communication between the network entity 122a/122b and the UE 142. The transmit and receive beams for the network entity 122a/122b may or may not be the same. The transmit and receive directions for the UE 142 may or may not be the same.

The communication links 148 may utilize one or more carriers. The network entities and UEs may use spectrum up to Y MHz (e.g., 5, 10, 15, 20, 100, 400, etc. MHz) bandwidth per carrier allocated in a carrier aggregation of up to a total of Yx MHZ (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

The communication links 148 in the RAN 100 may further utilize one or more multiplexing and multiple access algorithms to enable simultaneous communication of the various devices. For example, 5G NR specifications provide multiple access for UL or reverse link transmissions from UEs 124, 126, and 144 to network entity 114, and for multiplexing DL or forward link transmissions from the network entity 114 to UEs 124, 126, and 144 utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the network entity 114 to UEs 124, 126, and 144 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

Further, the communication links 148 in the RAN 100 may utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancellation technologies. Full-duplex emulation is frequently implemented for wireless links by utilizing frequency division duplex (FDD) or spatial division duplex (SDD). In FDD, transmissions in different directions may operate at different carrier frequencies (e.g., within paired spectrum). In SDD, transmissions in different directions on a given channel are separated from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to herein as sub-band full duplex (SBFD), also known as flexible duplex (FD).

In various implementations, the communication links 148 in the RAN 100 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple RATs. For example, the holder of a license for a portion of licensed spectrum may provide licensed shared access (LSA) to share that spectrum with other parties, e.g., with suitable licensee-determined conditions to gain access.

The electromagnetic spectrum is often subdivided, based on frequency/wavelength, into various classes, bands, channels, etc. In 5G NR two initial operating bands have been identified as frequency range designations FR1 (410 MHZ-7.125 GHZ) and FR2 (24.25 GHz-52.6 GHZ). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHZ) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4-a or FR4-1 (52.6 GHz-71 GHZ), FR4 (52.6 GHZ-114.25 GHZ), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In some examples, access to the air interface may be scheduled, wherein a scheduling entity (e.g., a network entity 114) allocates resources for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, UEs (e.g., UE 124), which may be scheduled entities, may utilize resources allocated by the scheduling entity 114.

Network entities are not the only entities that may function as scheduling entities. That is, in some examples, a UE may function as a scheduling entity, scheduling resources for one or more scheduled entities (e.g., one or more other UEs). For example, two or more UEs (e.g., UEs 144 and 146) may communicate with each other using peer to peer (P2P) or sidelink signals via a sidelink 150 therebetween without relaying that communication through a network entity (e.g., network entity 114). In some examples, the UEs 144 and 146 may each function as a scheduling entity or transmitting sidelink device and/or a scheduled entity or a receiving sidelink device to communicate sidelink signals therebetween without relying on scheduling or control information from a network entity (e.g., network entity 114). In other examples, the network entity 114 may allocate resources to the UEs 144 and 146 for sidelink communication. For example, the UEs 144 and 146 may communicate using sidelink signaling in a P2P network, a device-to-device (D2D) network, vehicle-to-vehicle (V2V) network, a vehicle-to-everything (V2X), a mesh network, or other suitable network.

In some examples, a D2D relay framework may be included within a cellular network to facilitate relaying of communication to/from the network entity 114 via D2D links (e.g., sidelink 150). For example, one or more UEs (e.g., UE 144) within the coverage area of the network entity 114 may operate as a relaying UE to extend the coverage of the network entity 114, improve the transmission reliability to one or more UEs (e.g., UE 146), and/or to allow the network entity to recover from a failed UE link due to, for example, blockage or fading.

The wireless communications system may further include a Wi-Fi access point (AP) 176 in communication with Wi-Fi stations (STAs) 178 via communication links 180 in a 5 GHz unlicensed frequency spectrum. When communicating in an unlicensed frequency spectrum, the STAs 170/AP 176 may perform a clear channel assessment (CCA) prior to communicating in order to determine whether the channel is available.

The network entities 114, 116, 118, 120, and 122a/122b provide wireless access points to the core network 160 for any number of UEs or other mobile apparatuses via core network backhaul links 154. The core network backhaul links 154 may provide a connection between the network entities 114, 116, 118, 120, and 122a/122b and the core network 170. In some examples, the core network backhaul links 154 may include backhaul links 152 that provide interconnection between the respective network entities. The core network may be part of the wireless communication system and may be independent of the radio access technology used in the RAN 100. Various types of backhaul interfaces may be employed, such as a direct physical connection (wired or wireless), a virtual network, or the like using any suitable transport network.

The core network 160 may include an Access and Mobility Management Function (AMF) 162, other AMFs 168, a Session Management Function (SMF) 164, and a User Plane Function (UPF) 166. The AMF 162 may be in communication with a Unified Data Management (UDM) 170. The AMF 162 is the control node that processes the signaling between the UEs and the core network 160. Generally, the AMF 162 provides QoS flow and session management. All user Internet protocol (IP) packets are transferred through the UPF 166. The UPF 166 provides UE IP address allocation as well as other functions. The UPF 166 is configured to couple to IP Services 172. The IP Services 172 may include the Internet, an intranet, an IP Multimedia Subsystem (IMS), a PS Streaming Service, and/or other IP services.

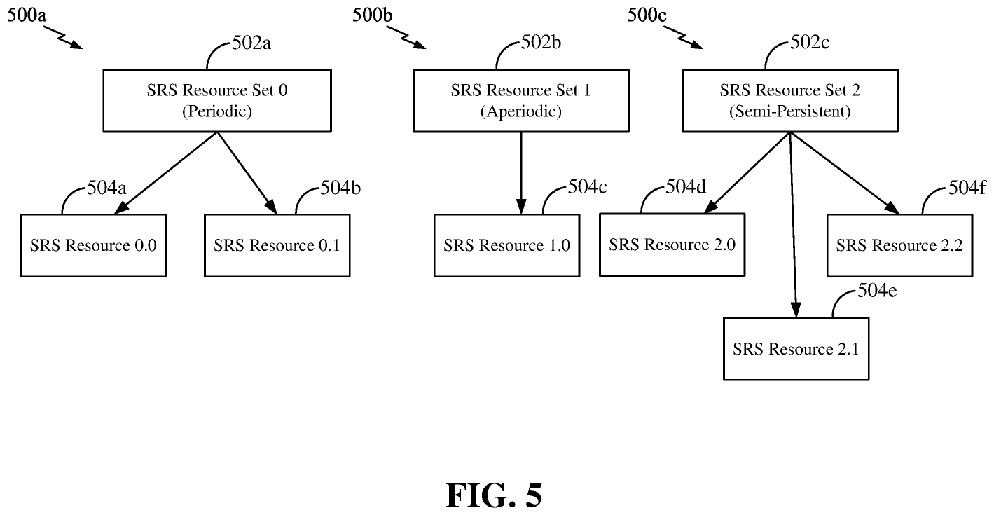

NR 5G wireless communication systems may support one or more frequency ranges, including FR1, FR2 or a legacy LTE frequency range. For example, the LTE frequency range may include the E-UTRA frequency bands between 350 MHz and 3.8 GHz. In some examples, each cell may support a single frequency range (e.g., FR1, FR2 or legacy LTE) and may further support one or more frequency bands (e.g., carrier frequencies) within a particular frequency range. In addition, one or more cells may operate as anchor cells enabling dual connectivity with neighbor cell(s) supporting a different frequency range. In some examples, one or more cells may be NR dual connectivity (NR DC) cells that support dual connectivity between FR1 and FR2 (e.g., FR1+FR2 DC). For example, a NR DC anchor cell may be configured for communication with UEs in the cell over FR1, and may further support dual connectivity by the UEs to enable simultaneous communication over FR1 with the NR DC anchor cell and over FR2 with one or more neighbor NR cells. In other examples, one or more cells may be Evolved-Universal Terrestrial Radio Access New Radio dual connectivity (EN-DC) that support dual connectivity between an LTE frequency band and either FR1 or FR2, as described in more detail below in connection with FIG. 5. For example, an LTE anchor cell may be configured for communication with UEs in the cell over an LTE frequency band, and may further support dual connectivity by the UEs to enable simultaneous communication over the LTE frequency band with the LTE anchor cell and over either FR1 or FR2 with one or more neighbor NR cells.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (cNB), NR BS, 5G NB (gNB), access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

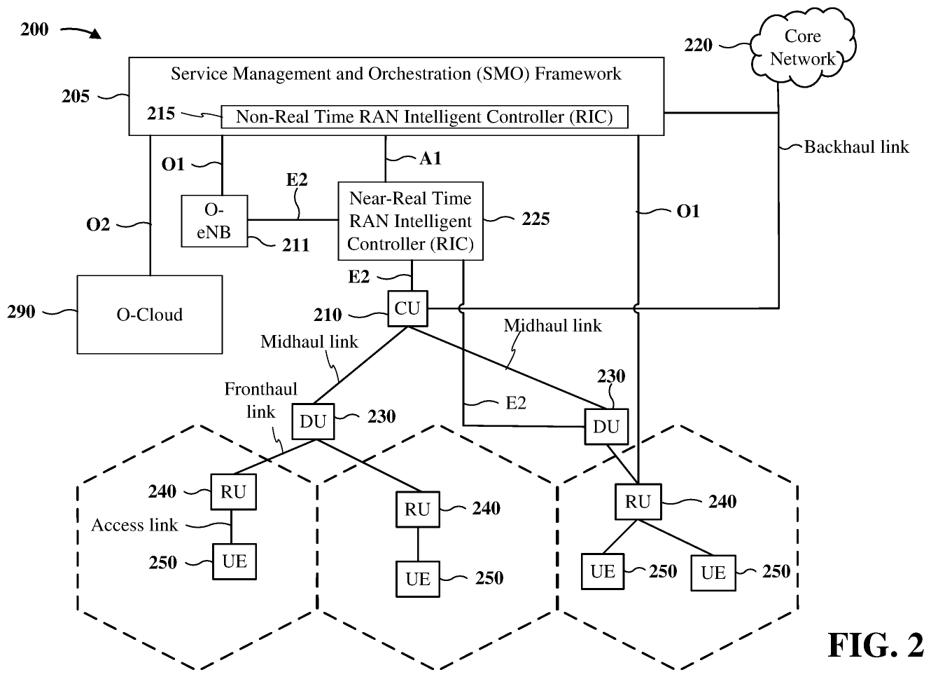

FIG. 2 shows a diagram illustrating an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUS) 240 via respective fronthaul links. The RUs 240 may communicate with respective UEs 250 via one or more radio frequency (RF) access links. In some implementations, the UE 250 may be simultaneously served by multiple RUs 240.

Each of the units, i.e., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communication with one or more UEs 250. In some implementations, real-time and non-real-time aspects of control and user plane communication with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 5G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-cNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

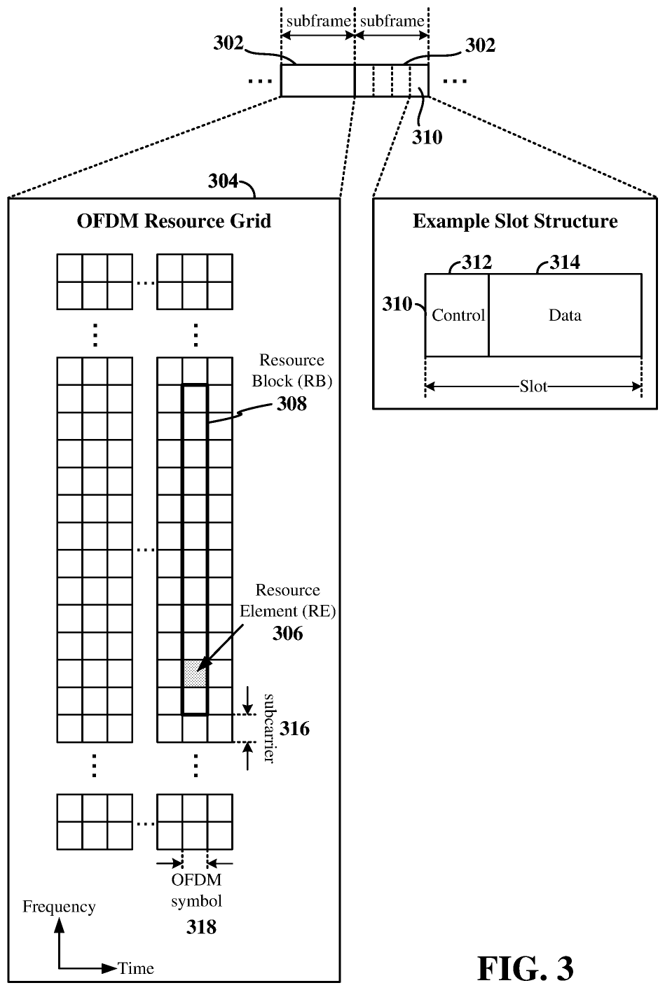

Various aspects of the present disclosure will be described with reference to an OFDM waveform, schematically illustrated in FIG. 3. It should be understood by those of ordinary skill in the art that the various aspects of the present disclosure may be applied to an SC-FDMA waveform in substantially the same way as described herein below. That is, while some examples of the present disclosure may focus on an OFDM link for clarity, it should be understood that the same principles may be applied as well to SC-FDMA waveforms.

Referring now to FIG. 3, an expanded view of an exemplary subframe 302 is illustrated, showing an OFDM resource grid. However, as those skilled in the art will readily appreciate, the PHY transmission structure for any particular application may vary from the example described here, depending on any number of factors. Here, time is in the horizontal direction with units of OFDM symbols; and frequency is in the vertical direction with units of subcarriers of the carrier.

The resource grid 304 may be used to schematically represent time-frequency resources for a given antenna port. That is, in a multiple-input-multiple-output (MIMO) implementation with multiple antenna ports available, a corresponding multiple number of resource grids 304 may be available for communication. The resource grid 304 is divided into multiple resource elements (REs) 306. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 308, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 308 entirely corresponds to a single direction of communication (either transmission or reception for a given device).

A set of continuous or discontinuous resource blocks may be referred to herein as a Resource Block Group (RBG), sub-band, or bandwidth part (BWP). A set of sub-bands or BWPs may span the entire bandwidth. Scheduling of scheduled entities (e.g., UEs) for downlink, uplink, or sidelink transmissions typically involves scheduling one or more resource elements 306 within one or more sub-bands or bandwidth parts (BWPs). Thus, a UE generally utilizes only a subset of the resource grid 304. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a network entity (e.g., gNB, eNB, etc.), or may be self-scheduled by a UE implementing D2D sidelink communication.

In this illustration, the RB 308 is shown as occupying less than the entire bandwidth of the subframe 302, with some subcarriers illustrated above and below the RB 308. In a given implementation, the subframe 302 may have a bandwidth corresponding to any number of one or more RBs 308. Further, in this illustration, the RB 308 is shown as occupying less than the entire duration of the subframe 302, although this is merely one possible example.

Each 1 ms subframe 302 may consist of one or multiple adjacent slots. In the example shown in FIG. 3, one subframe 302 includes four slots 310, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of one of the slots 310 illustrates the slot 310 including a control region 312 and a data region 314. In general, the control region 312 may carry control channels, and the data region 314 may carry data channels. Of course, a slot may contain all DL, all UL, or at least one DL portion and at least one UL portion. The structure illustrated in FIG. 3 is merely exemplary in nature, and different slot structures may be utilized, and may include one or more of each of the control region(s) and data region(s).

Although not illustrated in FIG. 3, the various REs 306 within a RB 308 may be scheduled to carry one or more physical channels, including control channels, shared channels, data channels, etc. Other REs 306 within the RB 308 may also carry pilots or reference signals. These pilots or reference signals may provide for a receiving device to perform channel estimation of the corresponding channel, which may enable coherent demodulation/detection of the control and/or data channels within the RB 308.

In some examples, the slot 310 may be utilized for broadcast, multicast, groupcast, or unicast communication. For example, a broadcast, multicast, or groupcast communication may refer to a point-to-multipoint transmission by one device (e.g., a network entity, UE, or other similar device) to other devices. Here, a broadcast communication is delivered to all devices, whereas a multicast or groupcast communication is delivered to multiple intended recipient devices. A unicast communication may refer to a point-to-point transmission by a one device to a single other device.

In an example of cellular communication over a cellular carrier via a Uu interface, for a DL transmission, the scheduling entity (e.g., a network entity) may allocate one or more REs 306 (e.g., within the control region 312) to carry DL control information including one or more DL control channels, such as a physical downlink control channel (PDCCH), to one or more scheduled entities (e.g., UEs). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry HARQ feedback transmissions such as an acknowledgement (ACK) or negative acknowledgement (NACK). HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The network entity may further allocate one or more REs 306 (e.g., in the control region 312 or the data region 314) to carry other DL signals, such as a demodulation reference signal (DMRS); a phase-tracking reference signal (PT-RS); a channel state information (CSI) reference signal (CSI-RS); and a synchronization signal block (SSB). SSBs may be broadcast at regular intervals based on a periodicity (e.g., 5, 10, 20, 40, 80, or 160 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType 1 (SIB1) that may include various additional system information. The MIB and SIB1 together provide the minimum system information (SI) for initial access. Examples of system information transmitted in the MIB may include, but are not limited to, a subcarrier spacing (e.g., default downlink numerology), system frame number, a configuration of a PDCCH control resource set (CORESET) (e.g., PDCCH CORESET0), a cell barred indicator, a cell reselection indicator, a raster offset, and a search space for SIB1. Examples of remaining minimum system information (RMSI) transmitted in the SIB1 may include, but are not limited to, a random access search space, a paging search space, downlink configuration information, and uplink configuration information. A network entity may transmit other system information (OSI) as well.

In an UL transmission, the scheduled entity (e.g., UE) may utilize one or more REs 306 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), i.e., request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, or any other suitable UCI.

In addition to control information, one or more REs 306 (e.g., within the data region 314) may be allocated for data traffic. Such data traffic may be carried on one or more traffic channels, such as, for a DL transmission, a physical downlink shared channel (PDSCH); or for an UL transmission, a physical uplink shared channel (PUSCH). In some examples, one or more REs 306 within the data region 314 may be configured to carry other signals, such as one or more SIBs and DMRSs. In some examples, the PDSCH may carry a plurality of SIBs, not limited to SIB1, discussed above. For example, the OSI may be provided in these SIBs, e.g., SIB2 and above.

In an example of sidelink communication over a sidelink carrier via a proximity service (ProSc) PC5 interface, the control region 312 of the slot 310 may include a physical sidelink control channel (PSCCH) including sidelink control information (SCI) transmitted by an initiating (transmitting) sidelink device (e.g., Tx V2X device or other Tx UE) towards a set of one or more other receiving sidelink devices (e.g., Rx V2X device or other Rx UE). The data region 314 of the slot 310 may include a physical sidelink shared channel (PSSCH) including sidelink data traffic transmitted by the initiating (transmitting) sidelink device within resources reserved over the sidelink carrier by the transmitting sidelink device via the SCI. Other information may further be transmitted over various REs 306 within slot 310. For example, HARQ feedback information may be transmitted in a physical sidelink feedback channel (PSFCH) within the slot 310 from the receiving sidelink device to the transmitting sidelink device. In addition, one or more reference signals, such as a sidelink SSB, a sidelink CSI-RS, a sidelink SRS, and/or a sidelink positioning reference signal (PRS) may be transmitted within the slot 310.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The channels or carriers illustrated in FIG. 3 are not necessarily all of the channels or carriers that may be utilized between devices, and those of ordinary skill in the art will recognize that other channels or carriers may be utilized in addition to those illustrated, such as other traffic, control, and feedback channels.

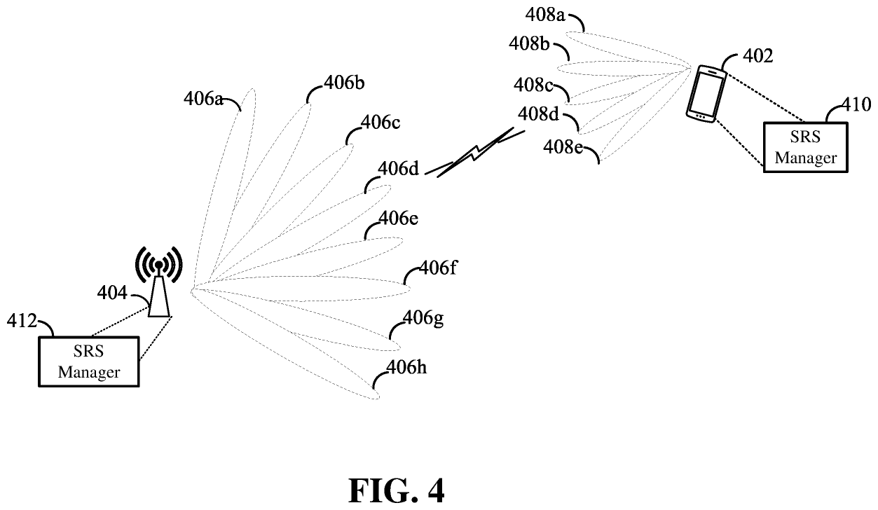

FIG. 4 is a diagram illustrating communication between a base station 404 and a UE 402 using beamformed signals according to some aspects. The base station 404 may be any of the base stations (e.g., gNBs) or scheduling entities illustrated in FIGS. 1 and/or 2, and the UE 402 may be any of the UEs or scheduled entities illustrated in FIGS. 1 and/or 2.

Beamforming is a signal processing technique that may be used at the transmitter or receiver to shape or steer an antenna beam (e.g., a transmit beam or receive beam) along a spatial path between the transmitter and the receiver. Beamforming may be achieved by combining the signals communicated via a set of antennas (e.g., antenna elements of an antenna array) such that some of the signals experience constructive interference while others experience destructive interference. To create the desired constructive/destructive interference, the transmitter or receiver may apply amplitude and/or phase offsets to signals transmitted or received from the set of antennas.

In the example shown in FIG. 4, the base station 404 is configured to generate a plurality of beams 406a-406h, each associated with a different beam direction. In addition, the UE 402 is configured to generate a plurality of beams 408a-408e, each associated with a different beam direction. The base station 404 and UE 402 may select one or more beams 406a-406h on the base station 404 and one or more beams 408a-408c on the UE 402 for communication of uplink and downlink signals therebetween using a downlink beam management scheme and/or an uplink beam management scheme.

In an example of a downlink beam management scheme for selection of downlink beams, the base station 404 may be configured to sweep or transmit on each of a plurality of downlink transmit beams 406a-406h during one or more synchronization slots. For example, the base station 404 may transmit a reference signal, such as an SSB or CSI-RS, on each beam in the different beam directions during the synchronization slot. Transmission of the beam reference signals may occur periodically (e.g., as configured via radio resource control (RRC) signaling by the gNB), semi-persistently (e.g., as configured via RRC signaling and activated/deactivated via medium access control-control element (MAC-CE) signaling by the gNB), or aperiodically (e.g., as triggered by the gNB via downlink control information (DCI)). It should be noted that while some beams are illustrated as adjacent to one another, such an arrangement may be different in different aspects. For example, downlink transmit beams 406a-406h transmitted during a same symbol may not be adjacent to one another. In some examples, the base station 404 may transmit more or less beams distributed in all directions (e.g., 360 degrees).

In addition, the UE 402 is configured to receive the downlink beam reference signals on a plurality of downlink receive beams 408a-408c. In some examples, the UE 402 searches for and identifies each of the downlink transmit beams 406a-406h based on the beam reference signals. The UE 402 then performs beam measurements (e.g., RSRP, SINR, RSRQ, etc.) on the beam reference signals on each of the downlink receive beams 408a-408c to determine the respective beam quality of each of the downlink transmit beams 406a-406h as measured on each of the downlink receive beams 408a-408c.

The UE 402 can generate and transmit an L1 measurement report, including the respective beam index (beam identifier (ID)) and beam measurement of one or more of the downlink transmit beam 406a-406h on one or more of the downlink receive beams 408a-408c to the base station 404. The base station 404 may then select one or more downlink transmit beams on which to transmit unicast downlink control information and/or user data traffic to the UE 402. In some examples, the selected downlink transmit beam(s) have the highest gain from the beam measurement report. In some examples, the UE 402 can further identify the downlink transmit beams selected by the base station from the beam measurements. Transmission of the beam measurement report may occur periodically (e.g., as configured via RRC signaling by the gNB), semi-persistently (e.g., as configured via RRC signaling and activated/deactivated via MAC-CE signaling by the gNB), or aperiodically (e.g., as triggered by the gNB via DCI).

The base station 404 or the UE 402 may further select a corresponding downlink receive beam on the UE 402 for each selected serving downlink transmit beam to form a respective downlink beam pair link (BPL) for each selected serving downlink transmit beam. For example, the UE 402 can utilize the beam measurements to select the corresponding downlink receive beam for each serving downlink transmit beam. In some examples, the selected downlink receive beam to pair with a particular downlink transmit beam may have the highest gain for that particular downlink transmit beam.

In one example, a single downlink transmit beam (e.g., beam 406d) on the base station 404 and a single downlink receive beam (e.g., beam 408c) on the UE may form a single downlink BPL used for communication between the base station 404 and the UE 402. In another example, multiple downlink transmit beams (e.g., beams 406c, 406d, and 406c) on the base station 404 and a single downlink receive beam (e.g., beam 408c) on the UE 402 may form respective downlink BPLs used for communication between the base station 404 and the UE 402. In another example, multiple downlink transmit beams (e.g., beams 406c, 406d, and 406c) on the base station 404 and multiple downlink receive beams (e.g., beams 408c and 408d) on the UE 402 may form multiple downlink BPLs used for communication between the base station 404 and the UE 402. In this example, a first downlink BPL may include downlink transmit beam 406c and downlink receive beam 408c, a second downlink BPL may include downlink transmit beam 408d and downlink receive beam 408c, and a third downlink BPL may include downlink transmit beam 408e and downlink receive beam 408d.

When the channel is reciprocal, the above-described downlink beam management scheme may also be used to select one or more uplink BPLs for uplink communication from the UE 402 to the base station 404. For example, the downlink BPL formed of beams 406d and 408e may also serve as an uplink BPL. Here, beam 408c is utilized as an uplink transmit beam, while beam 406d is utilized as an uplink receive beam.

In an example of an uplink beam management scheme, the UE 402 may be configured to sweep or transmit on each of a plurality of uplink transmit beams 408a-408c. For example, the UE 402 may transmit an SRS on each beam in the different beam directions. In addition, the base station 404 may be configured to receive the uplink beam reference signals on a plurality of uplink receive beams 406a-406h. In some examples, the base station 404 searches for and identifies each of the uplink transmit beams 408a-408e based on the beam reference signals. The base station 404 then performs beam measurements (e.g., RSRP, SINR, RSRQ, etc.) on the beam reference signals on each of the uplink receive beams 406a-406h to determine the respective beam quality of each of the uplink transmit beams 408a-408e as measured on each of the uplink receive beams 406a-406h.

The base station 404 may then select one or more uplink transmit beams on which the UE 402 will transmit unicast downlink control information and/or user data traffic to the base station 404. In some examples, the selected uplink transmit beam(s) have the highest gain. The base station 404 may further select a corresponding uplink receive beam on the base station 404 for each selected serving uplink transmit beam to form a respective uplink beam pair link (BPL) for each selected serving uplink transmit beam. For example, the base station 404 can utilize the uplink beam measurements to select the corresponding uplink receive beam for each serving uplink transmit beam. In some examples, the selected uplink receive beam to pair with a particular uplink transmit beam may have the highest gain for that particular uplink transmit beam.

The base station 404 may then notify the UE 402 of the selected uplink transmit beams. For example, the base station 404 may provide the SRS resource identifiers (SRIs) identifying the SRSs transmitted on the selected uplink transmit beams. In some examples, the base station 404 may apply each selected uplink transmit beam (and corresponding uplink receive beam) to an uplink signal (e.g., PUCCH, PUSCH, etc.) and transmit the respective SRIs associated with the selected uplink transmit beams applied to each uplink signal to the UE 402. When the channel is reciprocal, the above-described uplink beam management scheme may also be used to select one or more downlink BPLs for downlink communication from the base station 404 to the UE 402. For example, the uplink BPLs may also be utilized as downlink BPLs.

To facilitate transmission of SRSs using uplink beams from the UE 402 to the base station 404, each of the UE 402 and base station 406 may include a respective SRS manager 410 and 412, respectively, configured to utilize an SRS configuration for an SRS resource set including SRS resources. For example, the SRS manager 412 may be configured to generate the SRS configuration and provide the SRS configuration to the UE 402. In addition, the SRS manager 410 may be configured to utilize the SRS configuration to generate a plurality of SRSs for transmission towards the base station 404.

FIG. 5 is a diagram illustrating exemplary SRS configurations 500a-500c for SRS resource sets 502a-502c, each including SRS resources 504a-504f according to some aspects. An SRS resource set may include one or more SRS resources. For example, SRS resource set 502a (SRS Resource Set 0) includes SRS resources 504a and 504b (SRS Resource 0.0 and SRS Resource 0.1), SRS resource set 502b (SRS Resource Set 1) includes SRS resource 504c (SRS Resource 1.0), and SRS resource set 502c (SRS Resource Set 2) includes SRS resource sets 504d, 504c, and 504f (SRS Resource 2.0, SRS Resource 2.1, and SRS Resource 2.2).

As indicated in FIG. 5, multiple SRS resource sets 502a-502c may be configured for a UE. In addition, each SRS resource set 502a-502c may be configured to be periodic, aperiodic, or semi-persistent, such that each of the SRS resources within the corresponding SRS resource set are periodic, aperiodic, or semi-persistent, respectively. For example, the SRS resources 504a and 504b within SRS resource set 502a may be periodic SRS resources, the SRS resource 504c within SRS resource set 502b may be aperiodic SRS resources, and the SRS resources 504d-504f within SRS resource set 502c may be semi-persistent SRS resources.

Each SRS resource 504a-504f includes a set of SRS resource parameters configuring the SRS resource. For example, the SRS resource parameters may include a set of port(s) (e.g., uplink beam), number of consecutive symbols, time domain allocation, repetition, transmission comb structure, bandwidth, and other suitable parameters. Each SRS may further be quasi co-located (QCL'ed) with another reference signal, such as an SSB, CSI-RS, or another SRS. Thus, based on the QCL association (e.g., with an SSB beam, CSI-RS beam, or SRS beam), the SRS resource may be transmitted with the same spatial domain filter utilized for reception/transmission of the indicated reference signal (e.g., SSB beam, CSI-RS beam, or SRS beam).

The respective sets of SRS resource parameters for each of the SRS resources in a particular SRS resource set collectively form the SRS resource set parameters for the SRS resource set. In addition, the SRS resource set itself may further include additional SRS resource set parameters. For example, the SRS resource set parameters for the aperiodic SRS resource set 502b may further include an aperiodic trigger state (e.g., codepoint) for the aperiodic SRS resource set 502b (e.g., up to three trigger states may be possible, each mapping to an aperiodic SRS resource set), a slot offset between the slot including the DCI triggering the aperiodic SRS resource and transmission of the SRS (e.g., SRS is transmitted k slot(s) after the slot carrying the DCI containing the trigger state), and a CSI-RS resource identifier (CRI) associated with the aperiodic SRS resource set 502b for precoder estimation of the aperiodic SRSs. As another example, the SRS configuration for a periodic SRS resource set 502a or semi-persistent SRS resource set 502c may indicate the periodicity of the SRS resources (e.g., the periodicity of transmission of SRSs). The respective SRS resource set parameters then collectively form the SRS configuration 500a-500c of the corresponding SRS resource set 502a-502c.

As discussed above, there may be different usages for SRS resources. SRS resources may span 1, 2, 4, 8, or 12 adjacent symbols (e.g., OFDM symbols), with up to 8 antenna ports per SRS resource. Here, an antenna port refers to a logical antenna port corresponding to one or more antenna elements of an antenna array or antenna panel on the UE. One or more antenna ports of an SRS resource may be sounded in each symbol. An SRS can be transmitted anywhere within the slot. For example, an SRS may be transmitted within a slot after a PUSCH is communicated in that slot. The logical antenna port may simply referred to as a port.

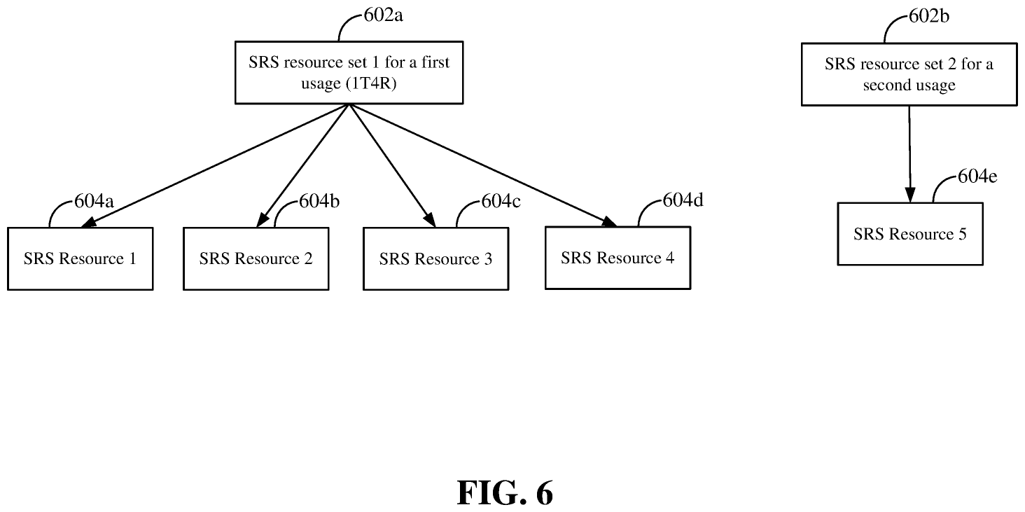

As discussed above, an SRS resource set may contain one or more SRS resources transmitted by a UE. In an example, an SRS resource may be indicated based on an SRS resource indicator (SRI) from within the SRS resource set. Further, as discussed above, a transmission of SRSs utilizing SRS resources within an SRS resource set may be aperiodic (e.g., triggered by DCI), semi-persistent, or periodic. A UE may be configured with multiple SRS resources, which may be grouped into one or more SRS resource sets based on a type of a usage, where various types of usages may include an antenna switching usage, a codebook-based usage, a non-codebook-based usage, or a beam management usage. FIG. 6 is an example diagram illustrating different SRS resource sets for different usages. In FIG. 6, a first SRS resource set 602a may be configured for a first usage (e.g., codebook-based usage), and include four SRS resources 604a, 604b, 604c, and 604d. In addition, a second SRS resource set 602b may be configured for a second usage (e.g., antenna switching usage) and include a single SRS resource 604c. In an example, transmissions of the SRS resources 604a, 604b, 604c, and 604d in the first SRS resource set 602a may be periodic, while a transmission of the SRS resource 604e in the second SRS resource set 602b may be aperiodic. SRS transmissions may be wideband/subband transmissions. For example, each SRS resource may be configured for the entire band instead of the narrower uplink sub-band to further improve the channel estimation quality and beam selection. In an example, an SRS bandwidth may be in a multiple of 4 PRBs.

As discussed above, a UE may utilize several ports to transmit SRSs to a network entity, where each port may be used to transmit a respective SRS. For example, a UE may utilize 8 ports to transmit SRSs for codebook-based PUSCH communication. Previously, for the codebook-based PUSCH communication, the UE has been configured to simultaneously transmit SRSs via all ports of the UE within a single OFDM symbol. Because all ports are utilized within a single OFDM symbol for SRS transmissions of SRSs, to determine the port transmit power used to transmit an SRS using each port, a total transmit power available for the SRS transmissions in a single OFDM symbol is equally divided by the number of ports.

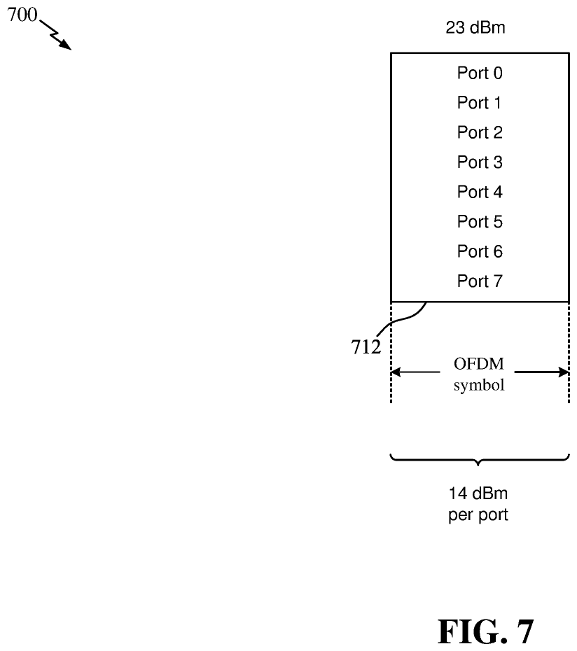

FIG. 7 is an example diagram 700 illustrating SRS transmissions using 8 ports within a single OFDM symbol. In the example shown in FIG. 7, the UE having 8 ports (Ports 0 through 7) available for SRS transmissions utilizes all 8 ports to transmit SRSs within a single OFDM symbol 712. In this example, the total transmit power available for SRS transmissions in a single OFDM symbol is 23 dBm. Because the UE has 8 ports, a port transmit power used for each port to transmit an SRS is determined by dividing 23 dBm by 8 ports, which is 14 dBm. In other words, within the single OFDM symbol 712, the UE may utilize each of the 8 ports at the port transmit power of 14 dBm to transmit an SRS.

More recently, an approach has been studied where the UE may be configured to transmit SRSs via multiple ports of the UE over a span of multiple OFDM symbols, even for codebook-based PUSCH communications, instead of utilizing all of the ports within a single OFDM symbol. For example, if the UE has 8 ports and 4 OFDM symbols are used to transmit SRSs, 2 ports may be assigned to each OFDM symbol so that the 8 ports may be utilized over 4 OFDM symbols to transmit SRSs. However, configuration of transmit powers for SRS ports for each OFDM symbol when multiple OFDM symbols are used to transmit SRSs via multiple ports has not been introduced.

According to some aspects of the disclosure, when multiple symbols (e.g., OFDM symbols) are utilized for SRS transmissions by multiple SRS ports, to determine a port transmit power for an SRS transmission per SRS port, a total transmit power available for each symbol is divided by a number of SRS ports that are simultaneously utilized to transmit SRSs within one symbol. In particular, after receiving an SRS configuration from a network entity, where the SRS configuration indicates that multiple SRS ports of an SRS resource are assigned to multiple symbols, the UE determines a port transmit power for each of the multiple SRS ports based on a total transmit power available for each of the symbols divided by a number of the SRS ports assigned in each of the symbols. In some aspects, the total transmit power may be derived based on an SRS power control loop driven by SRS power control commands indicated by the network entity. In some aspects, the SRSs are transmitted on an active uplink BWP of a carrier of a serving cell.

In some aspects, prior to receiving the SRS configuration, the UE may transmit a capability report and/or a power headroom report to the network entity, where the capability report and/or a power headroom report indicate the total transmit power available for each symbol. For example, during an initial access stage when the UE connects to the network entity, the UE may transmit the capability report to the network entity to indicate the UE's capability, and this capability report may indicate the total transmit power.

In some aspects, each symbol of the multiple symbols is assigned the same number of SRS ports. For example, if there are 8 SRS ports that are assigned to 4 OFDM symbols, each OFDM symbol may be assigned 2 SRS ports. In this example, a port transmit power for each SRS port may be calculated by dividing the total transmit power available for each OFDM symbol divided by 2 SRS ports, because 2 SRS ports are assigned per OFDM symbol. It is noted that there may be another example where different numbers of SRS ports may be assigned to different OFDM symbols.

After determining the port transmit power, the UE transmits, and the network entity receives, multiple SRSs respectively via the multiple SRS ports, where each SRS of the multiple SRSs is transmitted using the port transmit power via a respective SRS port of the multiple SRS ports in a respective symbol of the multiple symbols. In some aspects, the multiple SRSs may be for a codebook based PUSCH and/or for an antenna switching for downlink CSI estimation. In some aspects, the multiple SRSs may be for a non-codebook based PUSCH. Based on the multiple SRSs received, the network entity may estimate uplink channel qualities respectively associated with the multiple SRS ports. Subsequently, the network entity may select an SRS port out of the multiple SRS ports based on the estimation of the uplink channel qualities, and send a notification of the selected SRS port to the UE. For example, the selected SRS port may be estimated to have the highest uplink channel quality (e.g., signal strength) among the multiple SRS ports. Subsequently, the UE may utilize the selected SRS port to transmit an uplink communication such as a PUSCH communication.

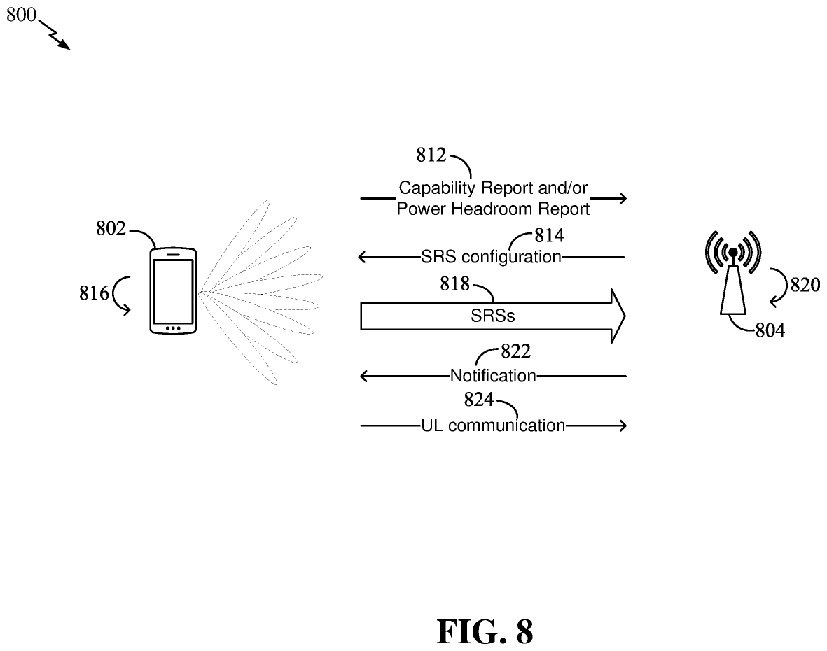

FIG. 8 is an example diagram 800 illustrating features performed by a UE 802 and a network entity 804, according to some aspects. According to some aspects, at 812, the UE 802 may transmit a capability report and/or a power headroom report to the network entity 804, e.g., during an initial access stage. In some aspects, the capability report and/or a power headroom report may indicate a total transmit power available for each OFDM symbol. At 814, the network entity 804 transmits, and the UE 802 receives, an SRS configuration indicating multiple SRS ports of an SRS resource assigned to multiple OFDM symbols. Subsequently, at 816, the UE 802 determines a port transmit power for each SRS port based on the total transmit power divided by a number of the multiple SRS ports assigned in each OFDM symbol. Then, at 818, the UE 802 transmits, and the network entity 804 receives, SRSs respectively via the multiple SRS ports, wherein each SRS of the SRSs is transmitted via a respective SRS port of the multiple SRS ports in a respective OFDM symbol of the multiple OFDM symbols using the port transmit power. Based on the received SRSs, at 820, the network entity 804 may estimate uplink channel qualities respectively associated with the multiple SRS ports, and may select an SRS port out of the multiple SRS ports. At 822, the network entity 804 may send a notification of the selected SRS port to the UE 802, such that the UE 802 may utilize the selected SRS port to transmit an uplink communication such as a PUSCH communication. At 824, the UE 802 may transmit an uplink communication using the selected SRS port indicated by the notification.

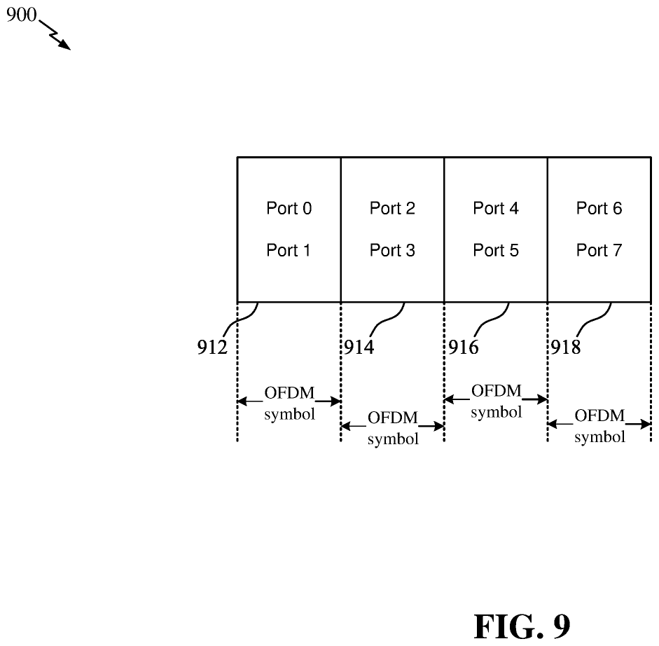

FIG. 9 is an example diagram 900 illustrating multiple ports of a UE assigned to multiple resources, according to some aspects. In the example shown in FIG. 9, the UE employs 8 SRS ports (Port 0 through 7), and 4 OFDM symbols including a first symbol 912, a second symbol 914, a third symbol 916 and a fourth symbol 918 are used to transmit with the 8 SRS ports. Each of the 4 OFDM symbols is assigned 2 SRS ports, and thus each OFDM symbol is used to transmit SRSs via 2 SRS ports. In particular, the first symbol 912 is assigned Port 0 and Port 1, the second symbol 914 is assigned Port 2 and Port 3, the third symbol 916 is assigned Port 4 and Port 5, and the fourth symbol 918 is assigned Port 6 and Port 7. In this example, because each OFDM symbol is assigned two SRS ports, each SRS port is used to transmit an SRS using a port transmit power determined based on a total transmit power available for each OFDM symbol divided by two SRS ports. Hence, in this example shown in FIG. 7, unlike the example illustrated in FIG. 7, the port transmit power is calculated by dividing the total transmit power by 2 SRS ports (e.g., per OFDM symbol), instead of dividing the total transmit power by a total number of SRS ports (8 ports). Therefore, according to some aspects of the disclosure, when multiple OFDM symbols are utilized for the SRS ports, more port transmit power may be allocated per SRS port than an example where all SRS ports are utilized within a single OFDM symbol.

For noncodebook-based PUSCH communication, the UE may indicate a specific number of ports used for simultaneously transmitting SRS ports within a single OFDM symbol. In this case, if a network entity configures a total of P SRS ports, the UE may indicate that the UE will transmit via less than P SRS ports within one OFDM symbol. For example, even if the total number of SRS ports is 8, the UE may indicate that it will only transmit via one SRS port per OFDM symbol, instead of transmitting via all 8 SRS ports in a single OFDM symbol. In another example, even if the total number of SRS ports is 8, the UE may indicate that it will only transmit via three SRS port per OFDM symbol. If the UE transmits via less than P SRS ports per OFDM, it may not be desirable scale down the total transmit power available by I/P to determine a port transmit power for each SRS port.

According to some aspects of the disclosure, when multiple OFDM symbols are utilized for SRS transmissions by multiple SRS ports, each maximum transmit power associated with a respective OFDM symbol of the multiple OFDM symbols may be determined to be less than or equal to an maximum data transmit power available for transmitting uplink data (e.g., PUSCH data) using the multiple SRS ports simultaneously. In particular, after receiving an SRS configuration from a network entity, where the SRS configuration indicates that multiple SRS ports of an SRS resource are assigned to multiple OFDM symbols, the UE determines maximum transmit powers respectively associated with multipole OFDM symbols, where each of the maximum transmit powers is associated with a respective OFDM symbol of the multiple OFDM symbol and is less than or equal to the maximum data transmit power available for transmitting uplink data using the multiple SRS ports simultaneously.

In some aspects, prior to receiving the SRS configuration, the UE may transmit a capability report and/or a power headroom report to the network entity. For example, during an initial access stage when the UE connects to the network entity, the UE may transmit the capability report and/or the power headroom report to the network entity to indicate the UE's capability. In some aspects, the capability report and/or the power headroom report may indicate the maximum transmit powers. In some aspects, the capability report and/or the power headroom report may indicate multiple power offsets, where the multiple power offsets indicate respective differences between the maximum transmit powers and the maximum data transmit power. In this aspect, to determine the maximum transmit powers for the multiple OFDM symbols, the UE may subtract the multiple power offsets from the maximum data transmit power, where each maximum transmit power is calculated by subtracting a respective multiple power offset from the maximum data transmit power.

After determining the maximum transmit powers respectively associated with multipole OFDM symbols, the UE transmits, and the network entity receives, SRSs respectively via the multiple ports in the multiple OFDM symbols. In each of the OFDM symbols, one or more SRSs of the multiple SRSs are transmitted respectively via one or more ports of the multiple SRS ports assigned to a respective OFDM symbol of the multiple OFDM symbols. These one or more SRSs are transmitted using a respective maximum transmit power of the maximum transmit powers that is associated with the respective OFDM symbol. Based on the multiple SRSs received, the network entity may estimate uplink channel qualities respectively associated with the multiple SRS ports. Subsequently, the network entity may select an SRS port out of the multiple SRS ports based on the estimation of the uplink channel qualities, and send a notification of the selected SRS port to the UE. For example, the selected SRS port may be estimated to have the highest uplink channel quality (e.g., signal strength) among the multiple SRS ports. The UE may utilize the selected SRS port to transmit an uplink communication such as a PUSCH communication.

Referring to FIG. 8, according to some aspects, at 812, the UE 802 may transmit a capability report and/or a power headroom report to the network entity 804, e.g., during an initial access stage. In some aspects, the capability report and/or the power headroom report may indicate maximum transmit powers, multiple power offsets, where the multiple power offsets indicate respective differences between the maximum transmit powers and the maximum data transmit power. At 814, the network entity 804 transmits, and the UE 802 receives, an SRS configuration indicating multiple SRS ports of an SRS resource assigned to multiple OFDM symbols. Subsequently, at 816, the UE 802 determines the maximum transmit powers respectively associated with the multiple OFDM symbols, each of the maximum transmit powers being associated with a respective OFDM symbol of the multiple OFDM symbol and being less than or equal to the maximum data transmit power available for transmitting uplink data using the multiple SRS ports simultaneously. Then, at 818, the UE 802 transmits, and the network entity 804 receives, SRSs respectively via the multiple SRS ports in the multiple OFDM symbols, wherein in each OFDM symbol, one or more SRSs of the SRSs are transmitted respectively via one or more ports of the multiple SRS ports assigned to a respective OFDM symbol of the multiple OFDM symbols, where the one or more SRSs is transmitted using a respective maximum transmit power of the maximum transmit powers that is associated with the respective OFDM symbol. Based on the received SRSs, at 820, the network entity 804 may estimate uplink channel qualities respectively associated with the multiple SRS ports, and may select an SRS port out of the multiple SRS ports. At 822, the network entity 804 may send a notification of the selected SRS port to the UE 802, such that, at 824, the UE 802 may utilize the selected SRS port to transmit an uplink communication such as a PUSCH communication.

In some aspects, each OFDM symbol of the multiple OFDM symbols is assigned the same number of SRS ports. For example, if there are 8 SRS ports that are assigned to 4 OFDM symbols, each OFDM symbol may be assigned 2 SRS ports. In this example, a port transmit power for each SRS port may be calculated by dividing the total transmit power available for each OFDM symbol divided by 2 SRS ports, because 2 SRS ports are assigned per OFDM symbol. It is noted that there may be another example where different numbers of SRS ports may be assigned to different OFDM symbols.

In some aspects, each OFDM symbol of the multiple OFDM symbols may be assigned a same number of SRS ports. In some aspects, each of the maximum transmit powers may have the same maximum transmit power value for each of the multiple OFDM symbols.

Each SRS port may be capable of transmitting an SRS or a PUSCH at a respective maximum port transmit power, which is a maximum power that the SRS port may use to transmit an SRS or a PUSCH. A maximum port transmit power for a particular SRS port may be based on a capability of a power amplifier for the particular SRS port. In some aspects, each of the multiple SRS ports may be capable of transmitting at a same maximum port transmit power, and this same maximum transmit power value for each of the multiple OFDM symbols may be based on one or more maximum port transmit powers respectively associated with the one or more ports assigned to the respective OFDM symbol. In some aspects, the multiple SRS ports may be capable of transmitting respectively at multiple port transmit powers, where each of the maximum transmit powers for each OFDM symbol may be based on one or more maximum port transmit powers respectively associated with the one or more SRS ports assigned to the respective OFDM symbol. For example, a maximum transmit power for a particular OFDM symbol may be calculated by calculating a sum of maximum port transmit powers of the SRS ports assigned to the particular OFDM symbol.

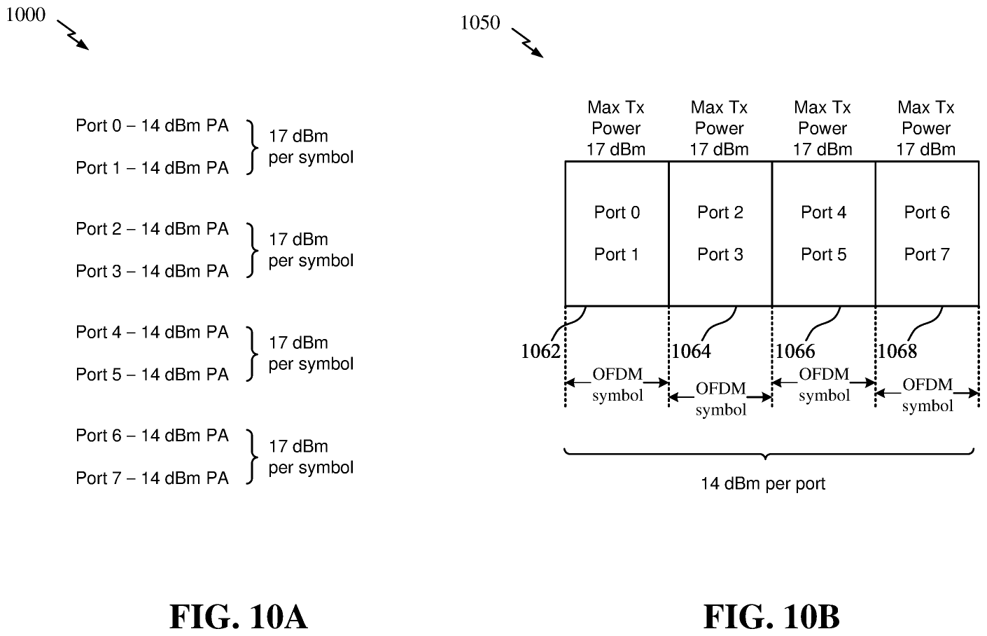

FIGS. 10A and 10B are example diagrams illustrating maximum transmit powers respectively for multiple OFDM symbols, according to some aspects. FIG. 10A is an example diagram 1000 illustrating SRS ports with their respective maximum port transmit powers. FIG. 10B is an example diagram 1010 illustrating the SRS ports assigned to the multiple OFDM symbols. In the example shown in FIGS. 10A and 10B, the UE employs 8 SRS ports (Port 0 through 7), and 4 OFDM symbols including a first symbol 1062, a second symbol 1064, a third symbol 1066 and a fourth symbol 1068 are used to transmit with the 8 SRS ports. Each of the 4 OFDM symbols is assigned 2 SRS ports (e.g., based on the SRS configuration), and thus each OFDM symbol is used to transmit SRSs via 2 SRS ports. In particular, the first symbol 1062 is assigned Port 0 and Port 1, the second symbol 1064 is assigned Port 2 and Port 3, the third symbol 1066 is assigned Port 4 and Port 5, and the fourth symbol 1068 is assigned Port 6 and Port 7. Hence, each maximum transmit power associated with a respective OFDM symbol is determined based on port transmit powers of 2 SRS ports assigned to the respective OFDM symbol.

As shown in FIG. 10A, each of the SRS ports is capable of transmitting at the maximum port transmit power of 14 dBm. In this example, the UE is capable of transmitting uplink data (e.g., PUSCH data) at a maximum data transmit power of 23 dBm using the 8 SRS ports simultaneously (e.g., within a single OFDM symbol), where 23 dBm is a sum of the maximum transmit powers of the 8 SRS ports, each maximum transmit power being 14 dBm. On the other hand, for transmitting the SRSs, because the 8 SRS ports are assigned to the 8 OFDM symbols, a subset (e.g., 2 SRS ports) of the 8 SRS ports is used to transmit SRSs in each of the 4 OFDM symbol. For each OFDM symbol, the maximum transmit power is based on the maximum port transmit powers of the 2 SRS ports in a respective OFDM symbol. In particular, the maximum transmit power for each OFDM symbol is a sum of the maximum port transmit powers of the 2 SRS ports in the respective OFDM symbol, and thus the maximum transmit power for each OFDM symbol is a sum of 14 dBm for one SRS port and 14 dBm for the other SRS port, which is 17 dBm, as shown in FIG. 10A. In this example, the maximum transmit power for each OFDM symbol is less than the maximum data transmit power. As shown in FIG. 10B, the maximum transmit power of 17 dBm is used for each of the 4 OFDM symbol, where each OFDM symbol is utilized by two SRS ports.

There is no uplink coherence requirement for SRSs for a noncodebook-based PUSCH transmission. Further, for a codebook-based PUSCH transmission with a non-coherent precoder, at least some of the SRS ports are not coherent with each other. In these cases, the maximum transmit powers may vary across different OFDM symbols. Hence, in some aspects, in a case where the multiple SRSs are for a noncodebook-based PUSCH transmission and/or for a codebook-based PUSCH transmission with a non-coherent precoder, at least one of the maximum transmit powers may be different from another one of the maximum transmit powers. For example, in this case, the maximum transmit powers may or may not have the same value. On the other hand, for SRSs for a codebook-based PUSCH transmission with coherent precoding, maximum transmit powers are set same across multiple OFDM symbols, in order to satisfy the coherence across different SRS ports. In some aspects, in a case where the SRSs are for a codebook-based PUSCH transmission with coherent precoding, if the SRS ports are coherent with each other, then the UE may set the maximum transmit powers to have the same value.

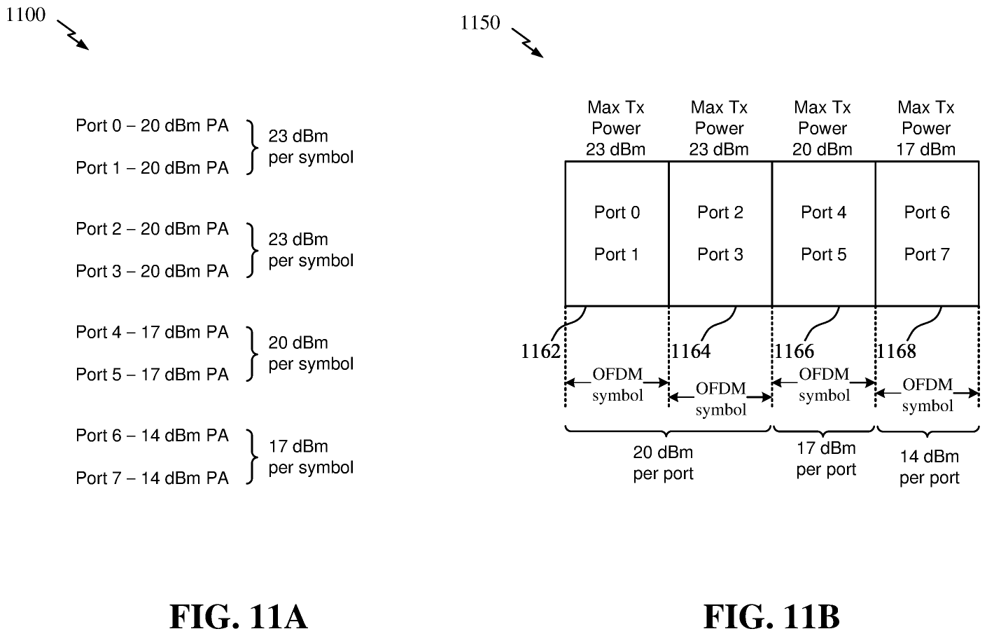

FIGS. 11A and 11B are example diagrams illustrating maximum transmit powers respectively for multiple OFDM symbols, where at least one of the maximum transmit powers is different from another maximum transmit power, according to some aspects. For example, the example diagrams of FIGS. 11A and 11B may be for a case where the multiple SRSs are for a noncodebook-based PUSCH transmission and/or for a codebook-based PUSCH transmission with a non-coherent precoder. FIG. 11A is an example diagram 1100 illustrating SRS ports with their respective maximum port transmit powers. FIG. 11B is an example diagram 1110 illustrating the SRS ports assigned to the multiple OFDM symbols. In the example shown in FIGS. 11A and 11B, the UE employs 8 SRS ports (Port 0 through 7), and 4 OFDM symbols including a first symbol 1162, a second symbol 1164, a third symbol 1166 and a fourth symbol 1168 are used to transmit with the 8 SRS ports. Each of the 4 OFDM symbols is assigned 2 SRS ports (e.g., based on the SRS configuration), and thus each OFDM symbol is used to transmit SRSs via 2 SRS ports. In particular, the first symbol 1162 is assigned Port 0 and Port 1, the second symbol 1164 is assigned Port 2 and Port 3, the third symbol 1166 is assigned Port 4 and Port 5, and the fourth symbol 1168 is assigned Port 6 and Port 7. Hence, each maximum transmit power associated with a respective OFDM symbol is determined based on port transmit powers of 2 SRS ports assigned to the respective OFDM symbol.

As shown in FIG. 11A, each of Port 0, Port 1, Port 2, and Port 3 is capable of transmitting at the maximum port transmit power of 20 dBm, each of Port 4 and Port 5 is capable of transmitting at the maximum port transmit power of 17 dBm, and each of Port 6 and Port 7 is capable of transmitting at the maximum port transmit power of 14 dBm. Hence, some of the maximum port transmit powers are different from one another. For each OFDM symbol, the maximum transmit power is based on the maximum port transmit powers of the 2 SRS ports in a respective OFDM symbol. In particular, the maximum transmit power for each OFDM symbol is a sum of the maximum port transmit powers of the 2 SRS ports in the respective OFDM symbol. Hence, as shown in FIG. 11A, the maximum transmit power for each of the first symbol 1162 and the second symbol 1164 is a sum of 20 dBm for one SRS port and 20 dBm for the other SRS port within each symbol, which is 23 dBm. As shown in FIG. 11A, the maximum transmit power for the third symbol 1166 is a sum of 17 dBm for one SRS port (Port 4) and 17 dBm for the other SRS port (Port 5) within the third symbol 1166, which is 20 dBm. Further, as shown in FIG. 11A, the maximum transmit power for the fourth symbol 1168 is a sum of 14 dBm for one SRS port (Port 6) and 14 dBm for the other SRS port (Port 7) within the fourth symbol 1168, which is 17 dBm. Hence, in this example, some of the maximum transmit powers are different from other maximum transmit powers. As shown in FIG. 11B, the maximum transmit power of 23 dBm is used for the first symbol 1162 and the second symbol 1164, the maximum transmit power of 20 dBm is used for the third symbol 1166, and the maximum transmit power of 17 dBm is used for the fourth symbol 1168, where each OFDM symbol is utilized by two SRS ports. Further, as shown in FIG. 11B, the maximum port transmit power for each of Port 0, Port 1, Port 2, and Port 3 is 20 dBm, the maximum port transmit power for each of Port 4 and Port 5 is 17 dBm, and the maximum port transmit power for each of Port 6 and Port 7 is 14 dBm.

As discussed above, if SRSs are for a codebook-based PUSCH transmission with a coherent precoder and/or for antenna switching for downlink CSI, the maximum transmit powers are set to a same value across different OFDM symbols, to maintain coherency for the SRS ports. In some aspects, in a case where multiple SRSs are for a codebook-based PUSCH transmission with a coherent precoder and/or for antenna switching for downlink CSI, in order to determine the maximum transmit powers, the UE may determine multiple maximum available transmit powers available respectively for the multiple OFDM symbols, and set each of the maximum transmit powers to a lowest maximum available transmit power out of the multiple maximum available transmit powers. For example, if all of the multiple ports are coherent with each other, then the maximum transmit powers are set to the same value (e.g., the lowest maximum available transmit power) across the multiple OFDM symbols.

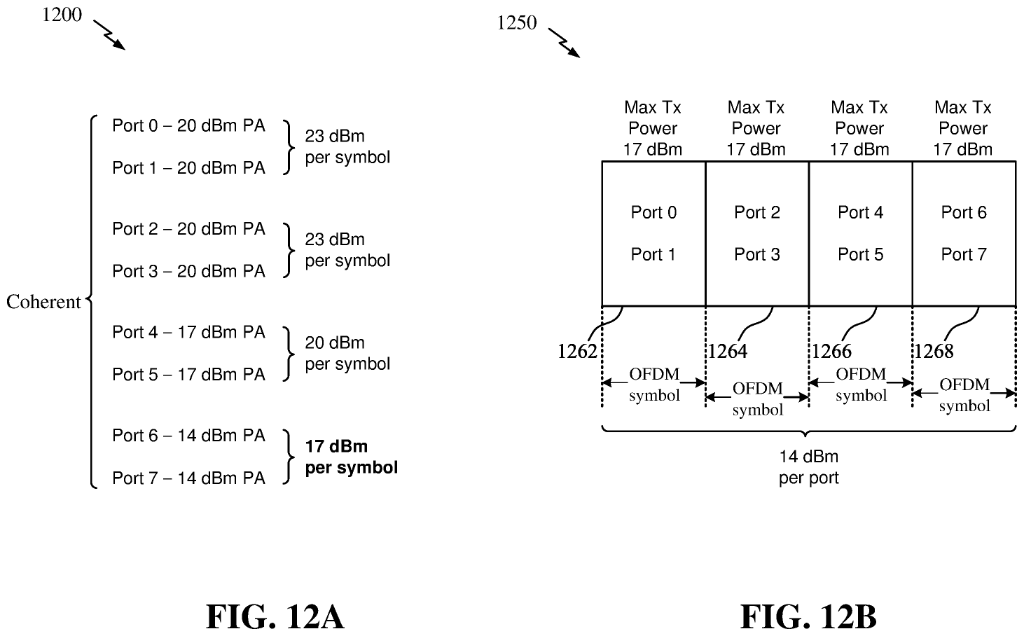

FIGS. 12A and 12B are example diagrams illustrating maximum transmit powers respectively for multiple OFDM symbols, where all of the OFDM symbols are coherent with each other, according to some aspects. For example, the example diagrams of FIGS. 12A and 12B may be for a case where multiple SRSs are for a codebook-based PUSCH transmission with a coherent precoder and/or for antenna switching for downlink CSI. FIG. 12A is an example diagram 1200 illustrating SRS ports with their respective maximum port transmit powers. FIG. 12B is an example diagram 1210 illustrating the SRS ports assigned to the multiple OFDM symbols. In the example shown in FIGS. 12A and 12B, the UE employs 8 SRS ports (Port 0 through 7), and 4 OFDM symbols including a first symbol 1262, a second symbol 1264, a third symbol 1266 and a fourth symbol 1268 are used to transmit with the 8 SRS ports. Each of the 4 OFDM symbols is assigned 2 SRS ports (e.g., based on the SRS configuration), and thus each OFDM symbol is used to transmit SRSs via 2 SRS ports. In particular, the first symbol 1262 is assigned Port 0 and Port 1, the second symbol 1264 is assigned Port 2 and Port 3, the third symbol 1266 is assigned Port 4 and Port 5, and the fourth symbol 1268 is assigned Port 6 and Port 7. Hence, each maximum transmit power associated with a respective OFDM symbol is determined based on port transmit powers of 2 SRS ports assigned to the respective OFDM symbol.

As shown in FIG. 12A, each of Port 0, Port 1, Port 2, and Port 3 is capable of transmitting at the maximum port transmit power of 20 dBm, each of Port 4 and Port 5 is capable of transmitting at the maximum port transmit power of 17 dBm, and each of Port 6 and Port 7 is capable of transmitting at the maximum port transmit power of 14 dBm. Hence, some of the maximum port transmit powers are different from one another. For each OFDM symbol, the maximum available transmit power available for a respective OFDM symbol is based on the maximum port transmit powers of the 2 SRS ports in the respective OFDM symbol. In particular, the maximum available transmit power for each OFDM symbol is a sum of the maximum port transmit powers of the 2 SRS ports in the respective OFDM symbol. Hence, as shown in FIG. 12A, the maximum available transmit power for each of the first symbol 1262 and the second symbol 1264 is a sum of 20 dBm for one SRS port and 20 dBm for the other SRS port within each symbol, which is 23 dBm. As shown in FIG. 12A, the maximum available transmit power for the third symbol 1266 is a sum of 17 dBm for one SRS port (Port 4) and 17 dBm for the other SRS port (Port 5) within the third symbol 1266, which is 20 dBm. Further, as shown in FIG. 12A, the maximum available transmit power for the fourth symbol 1268 is a sum of 14 dBm for one SRS port (Port 6) and 14 dBm for the other SRS port (Port 7) within the fourth symbol 1268, which is 17 dBm. However, in the case where the multiple SRSs are for a codebook-based PUSCH transmission with a coherent precoder and/or for antenna switching for downlink CSI, to satisfy the coherency, the maximum transmit power for each of the multiple OFDM symbols is set to a same value, which may be the lowest maximum available transmit power out of the multiple maximum available transmit powers for the multiple OFDM symbols. Hence, in this example, the lowest maximum available transmit power out of the multiple maximum available transmit powers for the 4 OFDM symbols is 17 dBm. Therefore, as shown in FIG. 12B, the UE sets each maximum transmit power for each OFDM symbol to 17 dBm. As such, as shown in FIG. 12B, the maximum port transmit power for each SRS port is 14 dBm.

In some cases, SRSs may be for a codebook-based PUSCH transmission with a partial coherent precoder, where the multiple OFDM symbols may be identified as two or more subsets of the multiple OFDM symbols, where all ports within a same subset are coherent with each other, while ports from different subsets may not be coherent with each other. In this case, the max transmit powers for OFDM symbols may not vary within the same subset, but may vary between different subsets that are not coherent with each other. In some aspects, in a case where the multiple SRSs are for a codebook-based PUSCH transmission with a partial coherent precoder, to determine the maximum transmit powers, the UE may determine a multiple maximum available transmit powers available respectively for the multiple OFDM symbols and identify two or more subsets of the multiple OFDM symbols, each subset of the two or more subsets including one or more resources of the multiple OFDM symbols, wherein all ports within each subset are coherent with each other. Then, the UE may determine two or more lowest maximum available transmit powers respectively corresponding to the two or more subsets of the multiple OFDM symbols, each of the two or more lowest maximum available transmit powers being determined based on a lowest maximum available transmit power out of maximum available transmit power within a respective subset of the two or more subset, and set each of the two or more lowest maximum available transmit powers to one or more OFDM symbols of the multiple OFDM symbols within a respective subset of the two or more subset.

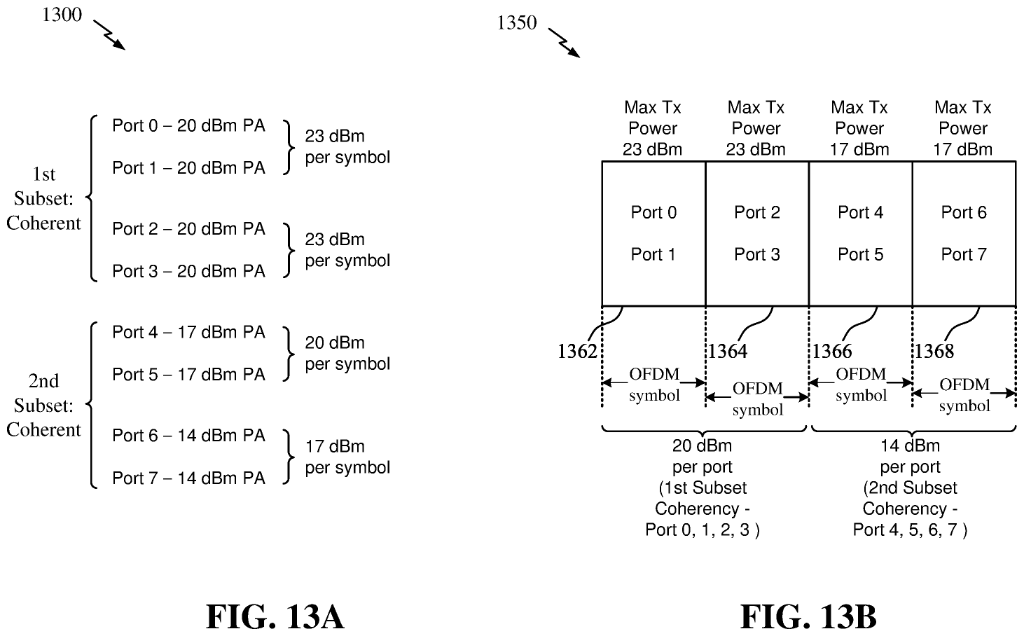

FIGS. 13A and 13B are example diagrams illustrating maximum transmit powers respectively for multiple OFDM symbols, where two subsets of OFDM symbols are not coherent with each other, according to some aspects. For example, the example diagrams of FIGS. 13A and 13B may be for a case where multiple SRSs are for a codebook-based PUSCH transmission with a partial coherent precoder. FIG. 13A is an example diagram 1300 illustrating SRS ports with their respective maximum port transmit powers. FIG. 13B is an example diagram 1310 illustrating the SRS ports assigned to the multiple OFDM symbols. In the example shown in FIGS. 13A and 13B, the UE employs 8 SRS ports (Port 0 through 7), and 4 OFDM symbols including a first symbol 1362, a second symbol 1364, a third symbol 1366 and a fourth symbol 1368 are used to transmit with the 8 SRS ports. Each of the 4 OFDM symbols is assigned 2 SRS ports (e.g., based on the SRS configuration), and thus each OFDM symbol is used to transmit SRSs via 2 SRS ports. In particular, the first symbol 1362 is assigned Port 0 and Port 1, the second symbol 1364 is assigned Port 2 and Port 3, the third symbol 1366 is assigned Port 4 and Port 5, and the fourth symbol 1368 is assigned Port 6 and Port 7. Hence, each maximum transmit power associated with a respective OFDM symbol is determined based on port transmit powers of 2 SRS ports assigned to the respective OFDM symbol.

As shown in FIG. 13A, each of Port 0, Port 1, Port 2, and Port 3 is capable of transmitting at the maximum port transmit power of 20 dBm, each of Port 4 and Port 5 is capable of transmitting at the maximum port transmit power of 17 dBm, and each of Port 6 and Port 7 is capable of transmitting at the maximum port transmit power of 14 dBm. Hence, some of the maximum port transmit powers are different from one another. For each OFDM symbol, the maximum available transmit power available for a respective OFDM symbol is based on the maximum port transmit powers of the 2 SRS ports in the respective OFDM symbol. In particular, the maximum available transmit power for each OFDM symbol is a sum of the maximum port transmit powers of the 2 SRS ports in the respective OFDM symbol. Hence, as shown in FIG. 13A, the maximum available transmit power for each of the first symbol 1362 and the second symbol 1364 is a sum of 20 dBm for one SRS port and 20 dBm for the other SRS port within each symbol, which is 23 dBm. As shown in FIG. 13A, the maximum available transmit power for the third symbol 1366 is a sum of 17 dBm for one SRS port (Port 4) and 17 dBm for the other SRS port (Port 5) within the third symbol 1366, which is 20 dBm. Further, as shown in FIG. 13A, the maximum available transmit power for the fourth symbol 1368 is a sum of 14 dBm for one SRS port (Port 6) and 14 dBm for the other SRS port (Port 7) within the fourth symbol 1368, which is 17 dBm.

In the example of FIGS. 13A and 13B where the multiple SRSs are for the codebook-based PUSCH transmission with a partial coherent precoder, the 4 OFDM symbols may be identified as two subsets of OFDM symbols, where a first subset includes the first symbol 1362 and the second symbol 1364 and a second subset includes the third symbol 1366 and the fourth symbol 1368. All ports within the first subset, including Port 0, Port 1, Port 2, and Port 3 are coherent with each other, and all ports within the second subset, including Port 4, Port 5, Port 6, and Port 7 are coherent with each other. On the other hand, the first subset and the second subset are not coherent with each other, and thus the ports of the first subset are not coherent with the ports of the second subset. To satisfy the coherency, the maximum transmit power for each of the multiple OFDM symbols is set to a same value within a particular subset, which may be the lowest maximum available transmit power out of the maximum available transmit powers for the OFDM symbols within the particular subset. In this example, for the first subset, the maximum available transmit powers for the first symbol 1362 and the second symbol 1364 are the same value, which is 23 dBm. Thus, shown in FIG. 13B, the UE sets the maximum transmit powers for the first symbol 1362 and the second symbol 1364 to 23 dBm. For the second subset, the lowest maximum available transmit power out of the maximum available transmit powers for the third symbol 1366 and the fourth symbol 1368 is 17 dBm. Hence, in this example, shown in FIG. 13B, the UE sets each maximum transmit power for each of the third symbol 1366 and the fourth symbol 1368 to 17 dBm. As such, as shown in FIG. 13B, the maximum port transmit power for each SRS port within the first subset is 20 dBm, and the maximum port transmit power for each SRS port within the first subset is 14 dBm.

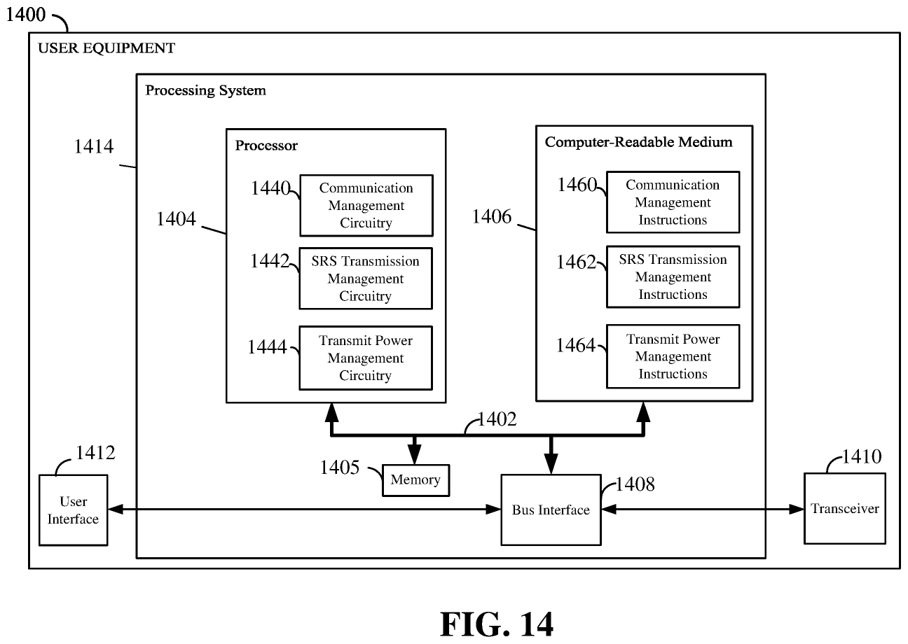

FIG. 14 is a block diagram illustrating an example of a hardware implementation for a UE 1400 employing a processing system 1414. For example, the UE 1400 may be a UE as illustrated in any one or more of FIGS. 1, 2, 4, and/or 8. In another example, the UE 1400 may be a UE as illustrated in any one or more of FIGS. 1, 2, 4, and/or 8.

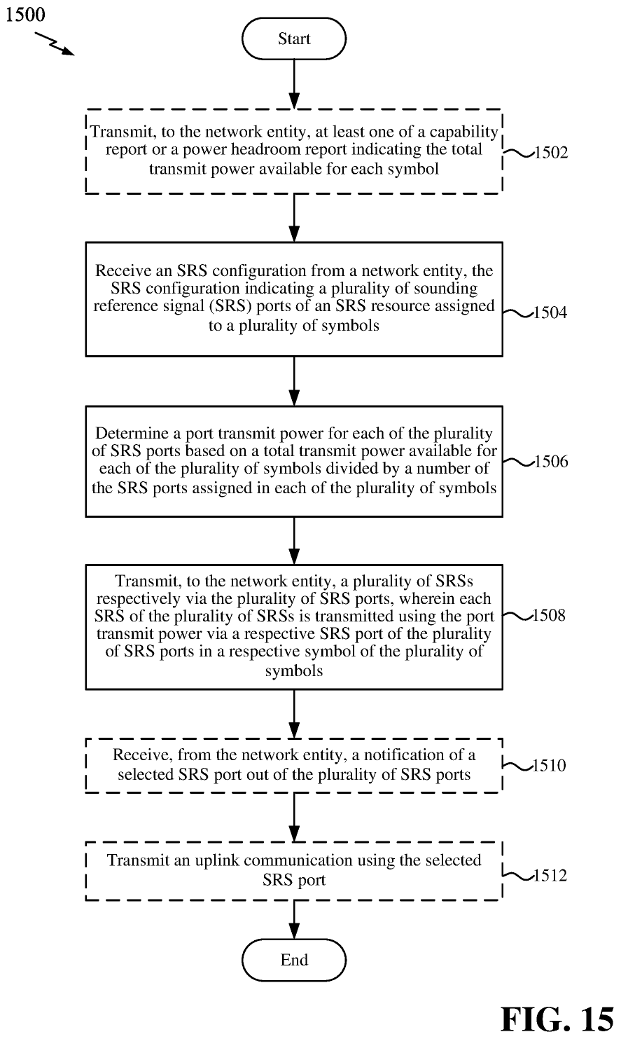

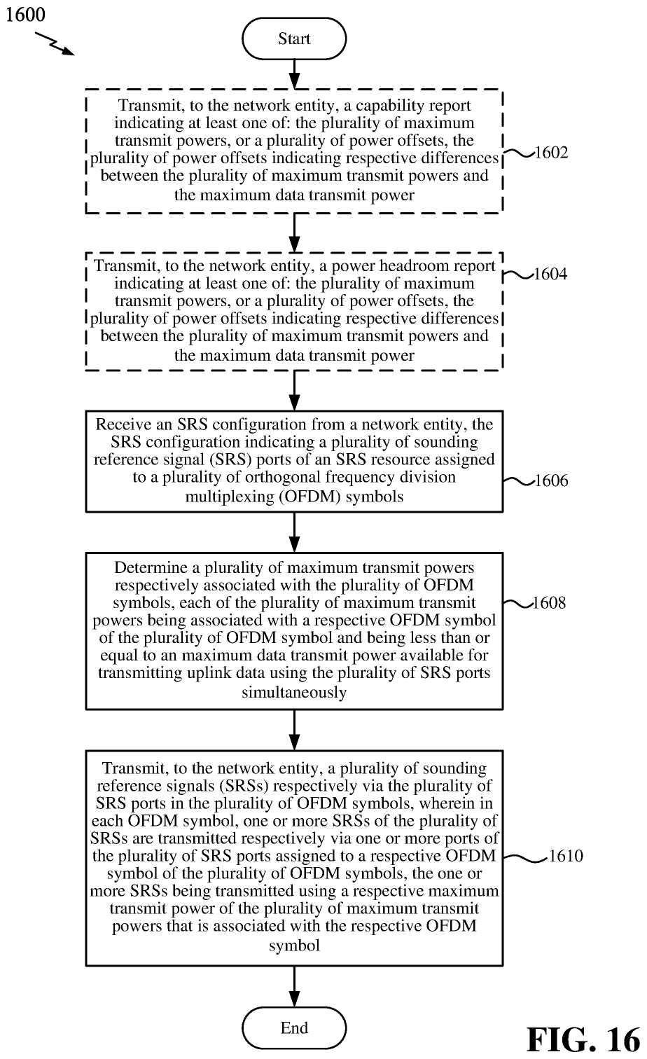

The UE 1400 may be implemented with a processing system 1414 that includes one or more processors 1404. Examples of processors 1404 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the UE 1400 may be configured to perform any one or more of the functions described herein. That is, the processor 1404, as utilized in a UE 1400, may be used to implement any one or more of the processes and procedures described below and illustrated in FIGS. 15 and 16.

In this example, the processing system 1414 may be implemented with a bus architecture, represented generally by the bus 1402. The bus 1402 may include any number of interconnecting buses and bridges depending on the specific application of the processing system 1414 and the overall design constraints. The bus 1402 communicatively couples together various circuits including one or more processors (represented generally by the processor 1404), a memory 1405, and computer-readable media (represented generally by the computer-readable storage medium 1406). The bus 1402 may also link various other circuits such as timing sources, peripherals, voltage regulators, and power management circuits, which are well known in the art, and therefore, will not be described any further. A bus interface 1408 provides an interface between the bus 1402 and a transceiver 1410. The transceiver 1410 provides a communication interface or means for communicating with various other apparatus over a transmission medium. Depending upon the nature of the apparatus, a user interface 1412 (e.g., keypad, display, speaker, microphone, joystick) may also be provided.

In some aspects of the disclosure, the processor 1404 may include communication management circuitry 1440 configured for various functions, including, for example, transmitting, to the network entity, at least one of a capability report or a power headroom report indicating the total transmit power available for each symbol. For example, the communication management circuitry 1440 may be configured to implement one or more of the functions described below in relation to FIG. 15, including, e.g., block 1502.

In some aspects, the communication management circuitry 1440 may be configured for various functions, including, for example, receiving, from the network entity, a notification of a selected SRS port out of the plurality of SRS ports. For example, the communication management circuitry 1440 may be configured to implement one or more of the functions described below in relation to FIG. 15, including, e.g., block 1510.

In some aspects, the communication management circuitry 1440 may be configured for various functions, including, for example, transmitting an uplink communication using the selected SRS port. For example, the communication management circuitry 1440 may be configured to implement one or more of the functions described below in relation to FIG. 15, including, e.g., block 1512.

In some aspects, the communication management circuitry 1440 is configured for various functions, including, for example, transmitting, to the network entity, a capability report indicating at least one of: the plurality of maximum transmit powers, or a plurality of power offsets, the plurality of power offsets indicating respective differences between the plurality of maximum transmit powers and the maximum data transmit power. For example, the communication management circuitry 1440 may be configured to implement one or more of the functions described below in relation to FIG. 16, including, e.g., block 1602.

In some aspects, the communication management circuitry 1440 is configured for various functions, including, for example, transmitting, to the network entity, a power headroom report indicating at least one of: the plurality of maximum transmit powers, or a plurality of power offsets, the plurality of power offsets indicating respective differences between the plurality of maximum transmit powers and the maximum data transmit power. For example, the communication management circuitry 1440 may be configured to implement one or more of the functions described below in relation to FIG. 16, including, e.g., block 1604.

In some aspects of the disclosure, the processor 1404 may include SRS transmission management circuitry 1442 configured for various functions, including, for example, receiving an SRS configuration from a network entity, the SRS configuration indicating a plurality of SRS ports of an SRS resource assigned to a plurality of symbols. For example, the SRS transmission management circuitry 1442 may be configured to implement one or more of the functions described below in relation to FIG. 15, including, e.g., block 1504.

In some aspects, the SRS transmission management circuitry 1442 is configured for various functions, including, for example, transmitting, to the network entity, a plurality of SRSs respectively via the plurality of SRS ports, wherein each SRS of the plurality of SRSs is transmitted using the port transmit power via a respective SRS port of the plurality of SRS ports in a respective symbol of the plurality of symbols. For example, the SRS transmission management circuitry 1442 may be configured to implement one or more of the functions described below in relation to FIG. 15, including, e.g., block 1508.

In some aspects, the SRS transmission management circuitry 1442 is configured for various functions, including, for example, receiving an SRS configuration from a network entity, the SRS configuration indicating a plurality of SRS ports of an SRS resource assigned to a plurality of OFDM symbols. For example, the SRS transmission management circuitry 1442 may be configured to implement one or more of the functions described below in relation to FIG. 16, including, e.g., block 1606.

In some aspects, the SRS transmission management circuitry 1442 is configured for various functions, including, for example, transmitting, to the network entity, a plurality of SRSs respectively via the plurality of SRS ports in the plurality of OFDM symbols, wherein in each OFDM symbol, one or more SRSs of the plurality of SRSs are transmitted respectively via one or more ports of the plurality of SRS ports assigned to a respective OFDM symbol of the plurality of OFDM symbols, the one or more SRSs being transmitted using a respective maximum transmit power of the plurality of maximum transmit powers that is associated with the respective OFDM symbol. For example, the SRS transmission management circuitry 1442 may be configured to implement one or more of the functions described below in relation to FIG. 16, including, e.g., block 1610.

In some aspects of the disclosure, the processor 1404 may include transmit power management circuitry 1444 configured for various functions, including, for example, determining a port transmit power for each of the plurality of SRS ports based on a total transmit power available for each of the plurality of symbols divided by a number of the SRS ports assigned in each of the plurality of symbols. For example, the transmit power management circuitry 1444 may be configured to implement one or more of the functions described below in relation to FIG. 15, including, e.g., block 1506.

In some aspects, the transmit power management circuitry 1444 is configured for various functions, including, for example, determining a plurality of maximum transmit powers respectively associated with the plurality of OFDM symbols, each of the plurality of maximum transmit powers being associated with a respective OFDM symbol of the plurality of OFDM symbol and being less than or equal to an maximum data transmit power available for transmitting uplink data using the plurality of SRS ports simultaneously. For example, the transmit power management circuitry 1444 may be configured to implement one or more of the functions described below in relation to FIG. 16, including, e.g., block 1608.

The processor 1404 is responsible for managing the bus 1402 and general processing, including the execution of software stored on the computer-readable storage medium 1406. The software, when executed by the processor 1404, causes the processing system 1414 to perform the various functions described below for any particular apparatus. The computer-readable storage medium 1406 and the memory 1405 may also be used for storing data that is manipulated by the processor 1404 when executing software.

One or more processors 1404 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable storage medium 1406. The computer-readable storage medium 1406 may be a non-transitory computer-readable storage medium. A non-transitory computer-readable storage medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an crasable PROM (EPROM), an electrically erasable PROM (EEPROM), a register, a removable disk, and any other suitable medium for storing software and/or instructions that may be accessed and read by a computer. The computer-readable storage medium 1406 may reside in the processing system 1414, external to the processing system 1414, or distributed across multiple entities including the processing system 1414. The computer-readable storage medium 1406 may be embodied in a computer program product. By way of example, a computer program product may include a computer-readable storage medium in packaging materials. Those skilled in the art will recognize how best to implement the described functionality presented throughout this disclosure depending on the particular application and the overall design constraints imposed on the overall system.

In some aspects of the disclosure, the computer-readable storage medium 1406 may include communication management software/instructions 1460 configured for various functions, including, for example, transmitting, to the network entity, at least one of a capability report or a power headroom report indicating the total transmit power available for each symbol. For example, the communication management software/instructions 1460 may be configured to implement one or more of the functions described below in relation to FIG. 15, including, e.g., block 1502.

In some aspects, the communication management software/instructions 1460 may be configured for various functions, including, for example, receiving, from the network entity, a notification of a selected SRS port out of the plurality of SRS ports. For example, the communication management software/instructions 1460 may be configured to implement one or more of the functions described below in relation to FIG. 15, including, e.g., block 1510.

In some aspects, the communication management software/instructions 1460 may be configured for various functions, including, for example, transmitting an uplink communication using the selected SRS port. For example, the communication management software/instructions 1460 may be configured to implement one or more of the functions described below in relation to FIG. 15, including, e.g., block 1512.

In some aspects, the communication management software/instructions 1460 is configured for various functions, including, for example, transmitting, to the network entity, a capability report indicating at least one of: the plurality of maximum transmit powers, or a plurality of power offsets, the plurality of power offsets indicating respective differences between the plurality of maximum transmit powers and the maximum data transmit power. For example, the communication management software/instructions 1460 may be configured to implement one or more of the functions described below in relation to FIG. 16, including, e.g., block 1602.

In some aspects, the communication management software/instructions 1460 is configured for various functions, including, for example, transmitting, to the network entity, a power headroom report indicating at least one of: the plurality of maximum transmit powers, or a plurality of power offsets, the plurality of power offsets indicating respective differences between the plurality of maximum transmit powers and the maximum data transmit power. For example, the communication management software/instructions 1460 may be configured to implement one or more of the functions described below in relation to FIG. 16, including, e.g., block 1604.

In some aspects of the disclosure, the computer-readable storage medium 1406 may include SRS transmission management software/instructions 1462 configured for various functions, including, for example, receiving an SRS configuration from a network entity, the SRS configuration indicating a plurality of SRS ports of an SRS resource assigned to a plurality of symbols. For example, the SRS transmission management software/instructions 1462 may be configured to implement one or more of the functions described below in relation to FIG. 15, including, e.g., block 1504.

In some aspects, the SRS transmission management software/instructions 1462 is configured for various functions, including, for example, transmitting, to the network entity, a plurality of SRSs respectively via the plurality of SRS ports, wherein each SRS of the plurality of SRSs is transmitted using the port transmit power via a respective SRS port of the plurality of SRS ports in a respective symbol of the plurality of symbols. For example, the SRS transmission management software/instructions 1462 may be configured to implement one or more of the functions described below in relation to FIG. 15, including, e.g., block 1508.

In some aspects, the SRS transmission management software/instructions 1462 is configured for various functions, including, for example, receiving an SRS configuration from a network entity, the SRS configuration indicating a plurality of SRS ports of an SRS resource assigned to a plurality of OFDM symbols. For example, the SRS transmission management software/instructions 1462 may be configured to implement one or more of the functions described below in relation to FIG. 16, including, e.g., block 1606.

In some aspects, the SRS transmission management software/instructions 1462 is configured for various functions, including, for example, transmitting, to the network entity, a plurality of SRSs respectively via the plurality of SRS ports in the plurality of OFDM symbols, wherein in each OFDM symbol, one or more SRSs of the plurality of SRSs are transmitted respectively via one or more ports of the plurality of SRS ports assigned to a respective OFDM symbol of the plurality of OFDM symbols, the one or more SRSs being transmitted using a respective maximum transmit power of the plurality of maximum transmit powers that is associated with the respective OFDM symbol. For example, the SRS transmission management software/instructions 1462 may be configured to implement one or more of the functions described below in relation to FIG. 16, including, e.g., block 1610.

In some aspects of the disclosure, the computer-readable storage medium 1406 may include transmit power management software/instructions 1464 configured for various functions, including, for example, determining a port transmit power for each of the plurality of SRS ports based on a total transmit power available for each of the plurality of symbols divided by a number of the SRS ports assigned in each of the plurality of symbols. For example, the transmit power management software/instructions 1464 may be configured to implement one or more of the functions described below in relation to FIG. 15, including, e.g., block 1506.

In some aspects, the transmit power management software/instructions 1464 is configured for various functions, including, for example, determining a plurality of maximum transmit powers respectively associated with the plurality of OFDM symbols, each of the plurality of maximum transmit powers being associated with a respective OFDM symbol of the plurality of OFDM symbol and being less than or equal to an maximum data transmit power available for transmitting uplink data using the plurality of SRS ports simultaneously. For example, the transmit power management software/instructions 1464 may be configured to implement one or more of the functions described below in relation to FIG. 16, including, e.g., block 1608.

FIG. 15 is a flow chart illustrating an exemplary process 1500 for wireless communication by a UE in accordance with some aspects of the present disclosure. As described below, some or all illustrated features may be omitted in a particular implementation within the scope of the present disclosure, and some illustrated features may not be required for implementation of all embodiments. In some examples, the process 1500 may be carried out by the UE 1400 illustrated in FIG. 14. In some examples, the process 1500 may be carried out by any suitable apparatus or means for carrying out the functions or algorithm described below.

At block 1502, in some aspects, the UE may transmit, to the network entity, at least one of a capability report or a power headroom report indicating the total transmit power available for each symbol. For example, the communication management circuitry 1440 shown and described above in connection with FIG. 14 may provide means for transmitting the at least one of the capability report or the power headroom report.

At block 1504, the UE may receive an SRS configuration from a network entity, the SRS configuration indicating a plurality of SRS ports of an SRS resource assigned to a plurality of symbols. For example, the SRS transmission management circuitry 1442 shown and described above in connection with FIG. 14 may provide means for receiving the SRS configuration. In some aspects, the plurality of symbols are a plurality of OFDM symbols.

In some aspects, each symbol of the plurality of symbols may be assigned a same number of SRS ports

At block 1506, the UE may determine a port transmit power for each of the plurality of SRS ports based on a total transmit power available for each of the plurality of symbols divided by a number of the SRS ports assigned in each of the plurality of symbols. For example, the transmit power management circuitry 1444 shown and described above in connection with FIG. 14 may provide means for determining the port transmit power.

In some aspects, the total transmit power may be derived based on an SRS power control loop driven by SRS power control commands indicated by the network entity.

At block 1508, the UE may transmit, to the network entity, a plurality of SRSs respectively via the plurality of SRS ports, wherein each SRS of the plurality of SRSs is transmitted using the port transmit power via a respective SRS port of the plurality of SRS ports in a respective symbol of the plurality of symbols. For example, the SRS transmission management circuitry 1442 shown and described above in connection with FIG. 14 may provide means for transmitting the plurality of SRSs. In some aspects, the plurality of SRSs may be transmitted on an active uplink bandwidth part of a carrier of a serving cell.

In some aspects, the plurality of SRSs may be for a codebook based PUSCH, and/or for an antenna switching for downlink CSI estimation.

In some aspects, at block 1510, the UE may receive, from the network entity, a notification of a selected SRS port out of the plurality of SRS ports. For example, the communication management circuitry 1440 shown and described above in connection with FIG. 14 may provide means for receiving the notification.

In some aspects, at block 1512, the UE may transmit an uplink communication using the selected SRS port. For example, the communication management circuitry 1440 shown and described above in connection with FIG. 14 may provide means for transmitting the uplink communication.

In one configuration, the UE 1400 for wireless communication includes means for receiving an SRS configuration from a network entity, the SRS configuration indicating a plurality of sounding reference signal (SRS) ports of an SRS resource assigned to a plurality of orthogonal frequency division multiplexing (OFDM) symbols; means for determining a port transmit power for each of the plurality of SRS ports based on a total transmit power available for each of the plurality of OFDM symbols divided by a number of the SRS ports assigned in each of the plurality of OFDM symbols; and means for transmitting, to the network entity, a plurality of SRSs respectively via the plurality of SRS ports, wherein each SRS of the plurality of SRSs is transmitted using the port transmit power via a respective SRS port of the plurality of SRS ports in a respective OFDM symbol of the plurality of OFDM symbols. In some aspects, the UE 1400 may further include means for transmitting, to the network entity, at least one of a capability report or a power headroom report indicating the total transmit power available for each OFDM symbol. In some aspects, the UE 1400 may further include means for receiving, from the network entity, a notification of a selected SRS port out of the plurality of SRS ports, and means for transmitting an uplink communication using the selected SRS port. In one aspect, the aforementioned means may be the processor(s) 1404 shown in FIG. 14 configured to perform the functions recited by the aforementioned means. In another aspect, the aforementioned means may be a circuit or any apparatus configured to perform the functions recited by the aforementioned means.

FIG. 16 is a flow chart illustrating an exemplary process 1600 for wireless communication by a UE in accordance with some aspects of the present disclosure. As described below, some or all illustrated features may be omitted in a particular implementation within the scope of the present disclosure, and some illustrated features may not be required for implementation of all embodiments. In some examples, the process 1600 may be carried out by the UE 1400 illustrated in FIG. 14. In some examples, the process 1600 may be carried out by any suitable apparatus or means for carrying out the functions or algorithm described below.

At block 1602, in some aspects, the UE may transmit, to the network entity, a capability report indicating at least one of: the plurality of maximum transmit powers, or a plurality of power offsets, the plurality of power offsets indicating respective differences between the plurality of maximum transmit powers and the maximum data transmit power. For example, the communication management circuitry 1440 shown and described above in connection with FIG. 14 may provide means for transmitting the capability report.

At block 1604, in some aspects, the UE may transmit, to the network entity, a power headroom report indicating at least one of: the plurality of maximum transmit powers, or a plurality of power offsets, the plurality of power offsets indicating respective differences between the plurality of maximum transmit powers and the maximum data transmit power. For example, the communication management circuitry 1440 shown and described above in connection with FIG. 14 may provide means for transmitting the capability report.

At block 1606, the UE may receive an SRS configuration from a network entity, the SRS configuration indicating a plurality of SRS ports of an SRS resource assigned to a plurality of OFDM symbols. For example, the SRS transmission management circuitry 1442 shown and described above in connection with FIG. 14 may provide means for receiving the SRS configuration.

In some aspects, each OFDM symbol of the plurality of OFDM symbols is assigned a same number of SRS ports.

At block 1608, the UE may determine a plurality of maximum transmit powers respectively associated with the plurality of OFDM symbols, each of the plurality of maximum transmit powers being associated with a respective OFDM symbol of the plurality of OFDM symbol and being less than or equal to an maximum data transmit power available for transmitting uplink data using the plurality of SRS ports simultaneously. For example, the transmit power management circuitry 1444 shown and described above in connection with FIG. 14 may provide means for determining the plurality of maximum transmit powers.

In some aspects, each of the plurality of maximum transmit powers has a same maximum transmit power value for each of the plurality of OFDM symbols.

In some aspects, each of the plurality of SRS ports is capable of transmitting at a same maximum port transmit power, and the same maximum transmit power value for each of the plurality of OFDM symbols is based on one or more maximum port transmit powers respectively associated with the one or more ports assigned to the respective OFDM symbol.

In some aspects, the plurality of SRS ports are capable of transmitting respectively at a plurality of maximum port transmit powers, and each of the plurality of maximum transmit powers for each OFDM symbol is based on one or more maximum port transmit powers respectively associated with the one or more ports assigned to the respective OFDM symbol.

At block 1610, the UE may transmit, to the network entity, a plurality of SRSs respectively via the plurality of SRS ports in the plurality of OFDM symbols, wherein in each OFDM symbol, one or more SRSs of the plurality of SRSs are transmitted respectively via one or more ports of the plurality of SRS ports assigned to a respective OFDM symbol of the plurality of OFDM symbols, the one or more SRSs being transmitted using a respective maximum transmit power of the plurality of maximum transmit powers that is associated with the respective OFDM symbol. For example, the SRS transmission management circuitry 1442 shown and described above in connection with FIG. 14 may provide means for transmitting the plurality of SRSs.

In some aspects, where the plurality of SRSs are for a noncodebook-based PUSCH transmission and/or for a codebook-based PUSCH transmission with a non-coherent precoder, at least one of the plurality of maximum transmit powers is different from another one of the plurality of maximum transmit powers.

In some aspects, where the plurality of SRSs are for a codebook-based PUSCH transmission with a coherent precoder and/or for antenna switching for downlink CSI, the UE determining the plurality of maximum transmit powers at 1608 may determine a plurality of maximum available transmit powers available respectively for the plurality of OFDM symbols, and sett each of the plurality of maximum transmit powers to a lowest maximum available transmit power out of the plurality of maximum available transmit powers.

In some aspects, where the plurality of SRSs are for a codebook-based PUSCH transmission with a coherent precoder, the UE determining the plurality of maximum transmit powers at 1608 may determine a plurality of maximum available transmit powers available respectively for the plurality of OFDM symbols, identify two or more subsets of the plurality of OFDM symbols, each subset of the two or more subsets including one or more OFDM symbols of the plurality of OFDM symbols, wherein all SRS ports within each subset are coherent with each other, determine two or more lowest maximum available transmit powers respectively corresponding to the two or more subsets of the plurality of OFDM symbols, each of the two or more lowest maximum available transmit powers being determined based on a lowest maximum available transmit power out of maximum available transmit power within a respective subset of the two or more subset, and set each of the two or more lowest maximum available transmit powers to one or more OFDM symbols of the plurality of OFDM symbols within a respective subset of the two or more subset

In one configuration, the UE 1400 for wireless communication includes means for receiving an SRS configuration from a network entity, the SRS configuration indicating a plurality of SRS ports of an SRS resource assigned to a plurality of OFDM symbols; means for determining a plurality of maximum transmit powers respectively associated with the plurality of OFDM symbols, each of the plurality of maximum transmit powers being associated with a respective OFDM symbol of the plurality of OFDM symbol and being less than or equal to an maximum data transmit power available for transmitting uplink data using the plurality of SRS ports simultaneously; and means for transmitting, to the network entity, a plurality of SRSs respectively via the plurality of SRS ports in the plurality of OFDM symbols, wherein in each OFDM symbol, one or more SRSs of the plurality of SRSs are transmitted respectively via one or more ports of the plurality of SRS ports assigned to a respective OFDM symbol of the plurality of OFDM symbols, the one or more SRSs being transmitted using a respective maximum transmit power of the plurality of maximum transmit powers that is associated with the respective OFDM symbol. In some aspects, the UE 1400 may include means for transmitting, to the network entity, a capability report indicating at least one of: the plurality of maximum transmit powers, or a plurality of power offsets, the plurality of power offsets indicating respective differences between the plurality of maximum transmit powers and the maximum data transmit power. In some aspects, the UE 1400 may include means for transmitting, to the network entity, a power headroom report indicating at least one of: the plurality of maximum transmit powers, or a plurality of power offsets, the plurality of power offsets indicating respective differences between the plurality of maximum transmit powers and the maximum data transmit power. In one aspect, the aforementioned means may be the processor(s) 1404 shown in FIG. 14 configured to perform the functions recited by the aforementioned means. In another aspect, the aforementioned means may be a circuit or any apparatus configured to perform the functions recited by the aforementioned means.

Of course, in the above examples, the circuitry included in the processor 1404 is merely provided as an example, and other means for carrying out the described functions may be included within various aspects of the present disclosure, including but not limited to the instructions stored in the computer-readable storage medium 1406, or any other suitable apparatus or means described in any one of the FIGS. 1, 2, 4, and/or 8, and utilizing, for example, the processes and/or algorithms described herein in relation to FIG. 14.

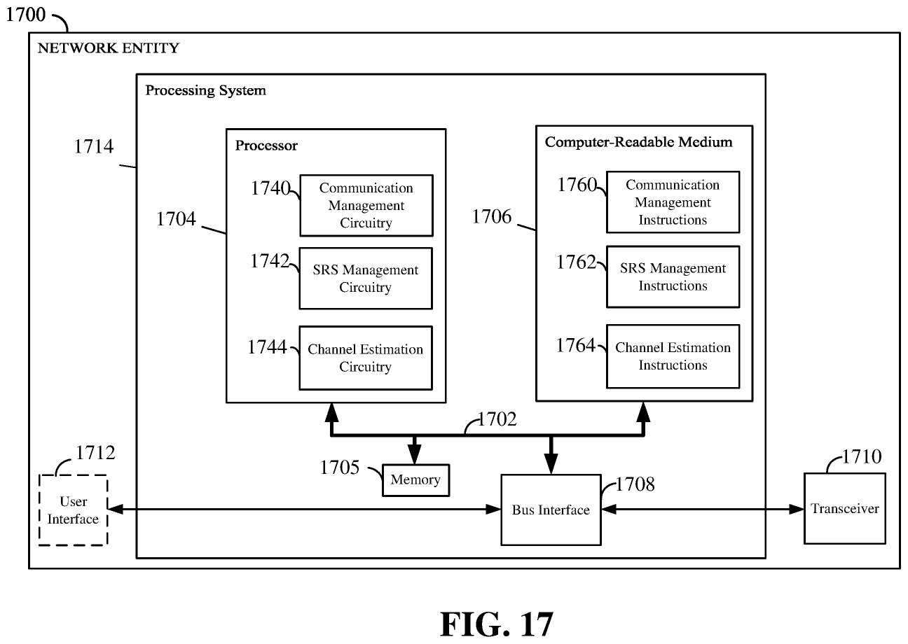

FIG. 17 is a conceptual diagram illustrating an example of a hardware implementation for an exemplary network entity 1700 employing a processing system 1714. In accordance with various aspects of the disclosure, an element, or any portion of an element, or any combination of elements may be implemented with a processing system 1714 that includes one or more processors 1704. For example, the network entity 1700 may be a network entity as illustrated in any one or more of FIGS. 1, 2, and/or 3.

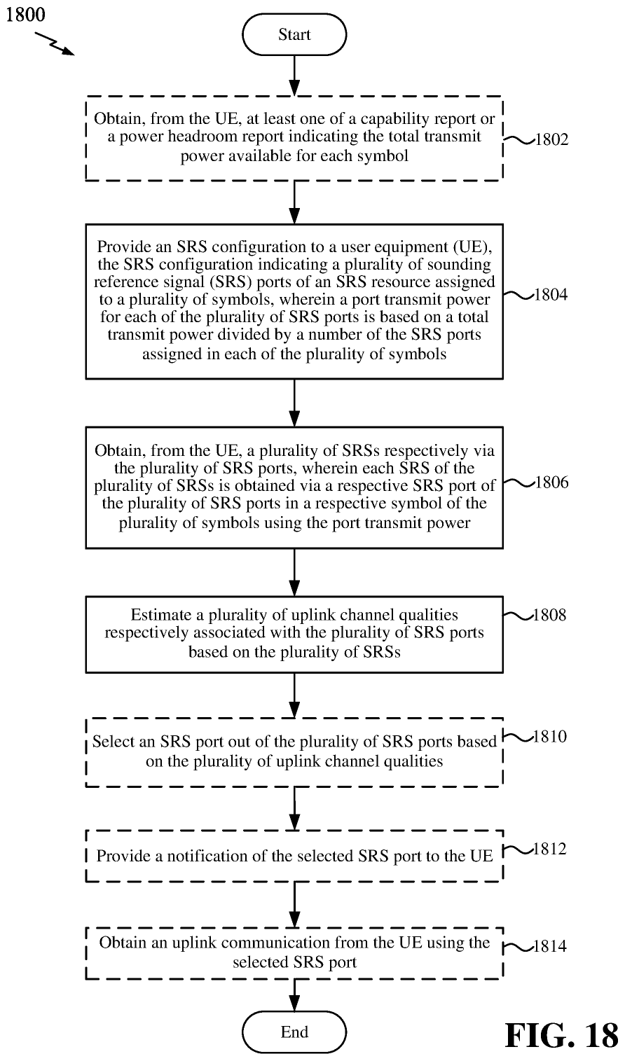

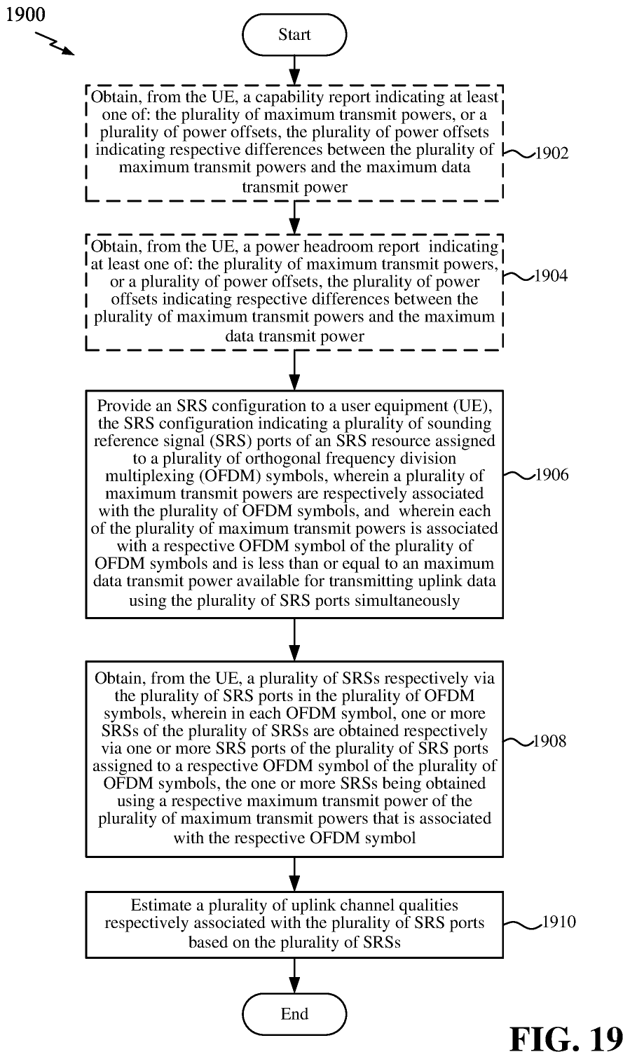

The processing system 1714 may be substantially the same as the processing system 1414 illustrated in FIG. 14, including a bus interface 1708, a bus 1702, memory 1705, a processor 1704, and a computer-readable storage medium 1706. Furthermore, the network entity 1700 may include a user interface 1712 and a transceiver 1710 substantially similar to those described above in FIG. 14. That is, the processor 1704, as utilized in a network entity 1700, may be used to implement any one or more of the processes described below and illustrated in FIGS. 18 and 19. Of course, such a user interface 1712 is optional, and may be omitted in some examples, such as a base station.

In some aspects of the disclosure, the processor 1704 may include communication management circuitry 1740 configured for various functions, including, for example, obtaining, from the UE, at least one of a capability report or a power headroom report indicating the total transmit power available for each symbol. For example, the communication management circuitry 1740 may be configured to implement one or more of the functions described below in relation to FIG. 18, including, e.g., block 1802.

In some aspects, the communication management circuitry 1740 may be configured for various functions, including, for example, providing a notification of the selected SRS port to the UE. For example, the communication management circuitry 1740 may be configured to implement one or more of the functions described below in relation to FIG. 18, including, e.g., block 1812.

In some aspects, the communication management circuitry 1740 may be configured for various functions, including, for example, obtaining an uplink communication from the UE using the selected SRS port. For example, the communication management circuitry 1740 may be configured to implement one or more of the functions described below in relation to FIG. 18, including, e.g., block 1814.

In some aspects, the communication management circuitry 1740 is configured for various functions, including, for example, obtaining, from the UE, a capability report indicating at least one of: the plurality of maximum transmit powers, or a plurality of power offsets, the plurality of power offsets indicating respective differences between the plurality of maximum transmit powers and the maximum data transmit power. For example, the communication management circuitry 1740 may be configured to implement one or more of the functions described below in relation to FIG. 19, including, e.g., block 1902.

In some aspects, the communication management circuitry 1740 is configured for various functions, including, for example, obtaining, from the UE, a power headroom report indicating at least one of: the plurality of maximum transmit powers, or a plurality of power offsets, the plurality of power offsets indicating respective differences between the plurality of maximum transmit powers and the maximum data transmit power. For example, the communication management circuitry 1740 may be configured to implement one or more of the functions described below in relation to FIG. 19, including, e.g., block 1904.

In some aspects of the disclosure, the processor 1704 may include SRS management circuitry 1742 configured for various functions, including, for example, providing an SRS configuration to a UE, the SRS configuration indicating a plurality of SRS ports of an SRS resource assigned to a plurality of symbols, wherein a port transmit power for each of the plurality of SRS ports is based on a total transmit power divided by a number of the SRS ports assigned in each of the plurality of symbols. For example, the SRS management circuitry 1742 may be configured to implement one or more of the functions described below in relation to FIG. 18, including, e.g., block 1804.

In some aspects, the SRS management circuitry 1742 is configured for various functions, including, for example, obtaining, from the UE, a plurality of SRSs respectively via the plurality of SRS ports, wherein each SRS of the plurality of SRSs is obtained via a respective SRS port of the plurality of SRS ports in a respective symbol of the plurality of symbols using the port transmit power. For example, the SRS management circuitry 1742 may be configured to implement one or more of the functions described below in relation to FIG. 18, including, e.g., block 1806.

In some aspects, the SRS management circuitry 1742 is configured for various functions, including, for example, providing an SRS configuration to a user equipment (UE), the SRS configuration indicating a plurality of SRS ports of an SRS resource assigned to a plurality of orthogonal frequency division multiplexing (OFDM) symbols, wherein a plurality of maximum transmit powers are respectively associated with the plurality of OFDM symbols, and wherein each of the plurality of maximum transmit powers is associated with a respective OFDM symbol of the plurality of OFDM symbols and is less than or equal to an maximum data transmit power available for transmitting uplink data using the plurality of SRS ports simultaneously. For example, the SRS management circuitry 1742 may be configured to implement one or more of the functions described below in relation to FIG. 19, including, e.g., block 1906.

In some aspects, the SRS management circuitry 1742 is configured for various functions, including, for example, obtaining, from the UE, a plurality of SRSs respectively via the plurality of SRS ports in the plurality of OFDM symbols, wherein in each OFDM symbol, one or more SRSs of the plurality of SRSs are obtained respectively via one or more SRS ports of the plurality of SRS ports assigned to a respective OFDM symbol of the plurality of OFDM symbols, the one or more SRSs being obtained using a respective maximum transmit power of the plurality of maximum transmit powers that is associated with the respective OFDM symbol. For example, the SRS management circuitry 1742 may be configured to implement one or more of the functions described below in relation to FIG. 19, including, e.g., block 1908.

In some aspects of the disclosure, the processor 1704 may include channel estimation circuitry 1744 configured for various functions, including, for example, estimating a plurality of uplink channel qualities respectively associated with the plurality of SRS ports based on the plurality of SRSs. For example, the channel estimation circuitry 1744 may be configured to implement one or more of the functions described below in relation to FIG. 18, including, e.g., block 1808.

In some aspects, the channel estimation circuitry 1744 may be configured for various functions, including, for example, selecting an SRS port out of the plurality of SRS ports based on the plurality of uplink channel qualities. For example, the channel estimation circuitry 1744 may be configured to implement one or more of the functions described below in relation to FIG. 18, including, e.g., block 1810.

In some aspects, the channel estimation circuitry 1744 is configured for various functions, including, for example, estimating a plurality of uplink channel qualities respectively associated with the plurality of SRS ports based on the plurality of SRSs. For example, the channel estimation circuitry 1744 may be configured to implement one or more of the functions described below in relation to FIG. 19, including, e.g., block 1910.

In some aspects of the disclosure, the computer-readable storage medium 1706 may include communication management software/instructions 1760 configured for various functions, including, for example, obtaining, from the UE, at least one of a capability report or a power headroom report indicating the total transmit power available for each symbol. For example, the communication management software/instructions 1760 may be configured to implement one or more of the functions described below in relation to FIG. 18, including, e.g., block 1802.

In some aspects, the communication management software/instructions 1760 may be configured for various functions, including, for example, providing a notification of the selected SRS port to the UE. For example, the communication management software/instructions 1760 may be configured to implement one or more of the functions described below in relation to FIG. 18, including, e.g., block 1812.

In some aspects, the communication management software/instructions 1760 may be configured for various functions, including, for example, obtaining an uplink communication from the UE using the selected SRS port. For example, the communication management software/instructions 1760 may be configured to implement one or more of the functions described below in relation to FIG. 18, including, e.g., block 1814.

In some aspects, the communication management software/instructions 1760 is configured for various functions, including, for example, obtaining, from the UE, a capability report indicating at least one of: the plurality of maximum transmit powers, or a plurality of power offsets, the plurality of power offsets indicating respective differences between the plurality of maximum transmit powers and the maximum data transmit power. For example, the communication management software/instructions 1760 may be configured to implement one or more of the functions described below in relation to FIG. 19, including, e.g., block 1902.

In some aspects, the communication management software/instructions 1760 is configured for various functions, including, for example, obtaining, from the UE, a power headroom report indicating at least one of: the plurality of maximum transmit powers, or a plurality of power offsets, the plurality of power offsets indicating respective differences between the plurality of maximum transmit powers and the maximum data transmit power. For example, the communication management software/instructions 1760 may be configured to implement one or more of the functions described below in relation to FIG. 19, including, e.g., block 1904.

In some aspects of the disclosure, the computer-readable storage medium 1706 may include SRS management software/instructions 1762 configured for various functions, including, for example, providing an SRS configuration to a UE, the SRS configuration indicating a plurality of SRS ports of an SRS resource assigned to a plurality of symbols, wherein a port transmit power for each of the plurality of SRS ports is based on a total transmit power divided by a number of the SRS ports assigned in each of the plurality of symbols. For example, the SRS management software/instructions 1762 may be configured to implement one or more of the functions described below in relation to FIG. 18, including, e.g., block 1804.

In some aspects, the SRS management software/instructions 1762 is configured for various functions, including, for example, obtaining, from the UE, a plurality of SRSs respectively via the plurality of SRS ports, wherein each SRS of the plurality of SRSs is obtained via a respective SRS port of the plurality of SRS ports in a respective symbol of the plurality of symbols using the port transmit power. For example, the SRS management software/instructions 1762 may be configured to implement one or more of the functions described below in relation to FIG. 18, including, e.g., block 1806.

In some aspects, the SRS management software/instructions 1762 is configured for various functions, including, for example, providing an SRS configuration to a user equipment (UE), the SRS configuration indicating a plurality of sounding reference signal (SRS) ports of an SRS resource assigned to a plurality of orthogonal frequency division multiplexing (OFDM) symbols, wherein a plurality of maximum transmit powers are respectively associated with the plurality of OFDM symbols, and wherein each of the plurality of maximum transmit powers is associated with a respective OFDM symbol of the plurality of OFDM symbols and is less than or equal to an maximum data transmit power available for transmitting uplink data using the plurality of SRS ports simultaneously. For example, the SRS management software/instructions 1762 may be configured to implement one or more of the functions described below in relation to FIG. 19, including, e.g., block 1906.

In some aspects, the SRS management software/instructions 1762 is configured for various functions, including, for example, obtaining, from the UE, a plurality of SRSs respectively via the plurality of SRS ports in the plurality of OFDM symbols, wherein in each OFDM symbol, one or more SRSs of the plurality of SRSs are obtained respectively via one or more SRS ports of the plurality of SRS ports assigned to a respective OFDM symbol of the plurality of OFDM symbols, the one or more SRSs being obtained using a respective maximum transmit power of the plurality of maximum transmit powers that is associated with the respective OFDM symbol. For example, the SRS management software/instructions 1762 may be configured to implement one or more of the functions described below in relation to FIG. 19, including, e.g., block 1908.

In some aspects of the disclosure, the computer-readable storage medium 1706 may include channel estimation software/instructions 1764 configured for various functions, including, for example, estimating a plurality of uplink channel qualities respectively associated with the plurality of SRS ports based on the plurality of SRSs. For example, the channel estimation software/instructions 1764 may be configured to implement one or more of the functions described below in relation to FIG. 18, including, e.g., block 1808.

In some aspects, the channel estimation software/instructions 1764 may be configured for various functions, including, for example, selecting an SRS port out of the plurality of SRS ports based on the plurality of uplink channel qualities. For example, the channel estimation software/instructions 1764 may be configured to implement one or more of the functions described below in relation to FIG. 18, including, e.g., block 1810.

In some aspects, the channel estimation software/instructions 1764 is configured for various functions, including, for example, estimating a plurality of uplink channel qualities respectively associated with the plurality of SRS ports based on the plurality of SRSs. For example, the channel estimation software/instructions 1764 may be configured to implement one or more of the functions described below in relation to FIG. 19, including, e.g., block 1910.

FIG. 18 is a flow chart illustrating an exemplary process 1800 for wireless communication by a network entity in accordance with some aspects of the present disclosure. As described below, some or all illustrated features may be omitted in a particular implementation within the scope of the present disclosure, and some illustrated features may not be required for implementation of all embodiments. In some examples, the process 1800 may be carried out by the network entity 1700 illustrated in FIG. 17. In some examples, the process 1800 may be carried out by any suitable apparatus or means for carrying out the functions or algorithm described below.

At block 1802, in some aspects, the network entity may obtain, from the UE, at least one of a capability report or a power headroom report indicating the total transmit power available for each symbol. For example, the communication management circuitry 1740 shown and described above in connection with FIG. 17 may provide means for obtaining the at least one of the capability report or a power headroom report. In some aspects, the plurality of symbols may be a plurality of OFDM symbols.

At block 1804, the network entity may provide an SRS configuration to a UE, the SRS configuration indicating a plurality of SRS ports of an SRS resource assigned to a plurality of symbols, wherein a port transmit power for each of the plurality of SRS ports is based on a total transmit power divided by a number of the SRS ports assigned in each of the plurality of symbols. For example, the SRS management circuitry 1742 shown and described above in connection with FIG. 17 may provide means for providing the SRS configuration.

In some aspects, each symbol of the plurality of symbols may be assigned a same number of SRS ports.

At block 1806, the network entity may obtain, from the UE, a plurality of SRSs respectively via the plurality of SRS ports, wherein each SRS of the plurality of SRSs is obtained via a respective SRS port of the plurality of SRS ports in a respective symbol of the plurality of symbols using the port transmit power. For example, the SRS management circuitry 1742 shown and described above in connection with FIG. 17 may provide means for obtaining the plurality of SRSs. In some aspects, the plurality of SRSs may be obtained on an active uplink bandwidth part of a carrier of a serving cell . . .

In some aspects, the total transmit power may be derived based on an SRS power control loop driven by SRS power control commands indicated by the network entity.

At block 1808, the network entity may estimate a plurality of uplink channel qualities respectively associated with the plurality of SRS ports based on the plurality of SRSs. For example, the channel estimation circuitry 1744 shown and described above in connection with FIG. 17 may provide means for estimating the plurality of uplink channel qualities.

In some aspects, the plurality of SRSs may be for a codebook based PUSCH and/or for an antenna switching for downlink CSI estimation.

In some aspects, at block 1810, the network entity may select an SRS port out of the plurality of SRS ports based on the plurality of uplink channel qualities. For example, the channel estimation circuitry 1744 shown and described above in connection with FIG. 17 may provide means for selecting the SRS port.

In some aspects, at block 1812, the network entity may provide a notification of the selected SRS port to the UE. For example, the communication management circuitry 1740 shown and described above in connection with FIG. 17 may provide means for providing the notification.

In some aspects, at block 1814, the network entity may obtain an uplink communication from the UE using the selected SRS port. For example, the communication management circuitry 1740 shown and described above in connection with FIG. 17 may provide means for obtaining the uplink communication.

In one configuration, the network entity 1700 for wireless communication includes means for providing an SRS configuration to a UE, the SRS configuration indicating a plurality of SRS ports of an SRS resource assigned to a plurality of symbols, wherein a port transmit power for each of the plurality of SRS ports is based on a total transmit power divided by a number of the SRS ports assigned in each of the plurality of symbols; means for obtaining, from the UE, a plurality of SRSs respectively via the plurality of SRS ports, wherein each SRS of the plurality of SRSs is obtained via a respective SRS port of the plurality of SRS ports in a respective symbol of the plurality of symbols using the port transmit power; and means for estimating a plurality of uplink channel qualities respectively associated with the plurality of SRS ports based on the plurality of SRSs. In some aspects, the network entity 1700 may further include means for obtaining, from the UE, at least one of a capability report or a power headroom report indicating the total transmit power available for each symbol. In some aspects, the network entity 1700 may further include means for selecting an SRS port out of the plurality of SRS ports based on the plurality of uplink channel qualities, means for providing a notification of the selected SRS port to the UE, and means for obtaining an uplink communication from the UE using the selected SRS port.

In one aspect, the aforementioned means may be the processor(s) 1704 shown in FIG. 17 configured to perform the functions recited by the aforementioned means. In another aspect, the aforementioned means may be a circuit or any apparatus configured to perform the functions recited by the aforementioned means.

FIG. 19 is a flow chart illustrating an exemplary process 1900 for wireless communication by a network entity in accordance with some aspects of the present disclosure. As described below, some or all illustrated features may be omitted in a particular implementation within the scope of the present disclosure, and some illustrated features may not be required for implementation of all embodiments. In some examples, the process 1900 may be carried out by the network entity 1700 illustrated in FIG. 17. In some examples, the process 1900 may be carried out by any suitable apparatus or means for carrying out the functions or algorithm described below.

At block 1902, in some aspects, the network entity may obtain, from the UE, a capability report indicating at least one of: the plurality of maximum transmit powers, or a plurality of power offsets, the plurality of power offsets indicating respective differences between the plurality of maximum transmit powers and the maximum data transmit power. For example, the communication management circuitry 1740 shown and described above in connection with FIG. 17 may provide means for providing the capability report.

At block 1904, in some aspects, the network entity may obtain, from the UE, a power headroom report indicating at least one of: the plurality of maximum transmit powers, or a plurality of power offsets, the plurality of power offsets indicating respective differences between the plurality of maximum transmit powers and the maximum data transmit power. For example, the communication management circuitry 1740 shown and described above in connection with FIG. 17 may provide means for providing the capability report.

At block 1906, in some aspects, the network entity may provide an SRS configuration to a UE, the SRS configuration indicating a plurality of SRS ports of an SRS resource assigned to a plurality of OFDM symbols, wherein a plurality of maximum transmit powers are respectively associated with the plurality of OFDM symbols, and wherein each of the plurality of maximum transmit powers is associated with a respective OFDM symbol of the plurality of OFDM symbols and is less than or equal to an maximum data transmit power available for transmitting uplink data using the plurality of SRS ports simultaneously. For example, the SRS management circuitry 1742 shown and described above in connection with FIG. 17 may provide means for providing the SRS configuration.

In some aspects, each OFDM symbol of the plurality of OFDM symbols is assigned a same number of SRS ports.

In some aspects, each of the plurality of maximum transmit powers has a same maximum transmit power value for each of the plurality of OFDM symbols.

In some aspects, each of the plurality of SRS ports is capable of transmitting at a same maximum port transmit power, and the same maximum transmit power value for each of the plurality of OFDM symbols is based on one or more maximum port transmit powers respectively associated with the one or more SRS ports assigned to the respective OFDM symbol.

At block 1908, in some aspects, the network entity may obtain, from the UE, a plurality of SRSs respectively via the plurality of SRS ports in the plurality of OFDM symbols, wherein in each OFDM symbol, one or more SRSs of the plurality of SRSs are obtained respectively via one or more SRS ports of the plurality of SRS ports assigned to a respective OFDM symbol of the plurality of OFDM symbols, the one or more SRSs being obtained using a respective maximum transmit power of the plurality of maximum transmit powers that is associated with the respective OFDM symbol. For example, the channel estimation circuitry 1744 shown and described above in connection with FIG. 17 may provide means for obtaining the plurality of SRSs.

In some aspects, the plurality of SRS ports are capable of transmitting respectively at a plurality of maximum port transmit powers, and each of the plurality of maximum transmit powers is based on one or more maximum port transmit powers respectively associated with the one or more SRS ports assigned to the respective OFDM symbol.

In some aspects, where the plurality of SRSs are for a noncodebook-based PUSCH transmission and/or for a codebook-based PUSCH transmission with a non-coherent precoder, at least one of the plurality of maximum transmit powers is different from another one of the plurality of maximum transmit powers.

In some aspects, where the plurality of SRSs are for a codebook-based PUSCH transmission with a coherent precoder and/or for antenna switching for downlink CSI, the plurality of maximum transmit powers are determined by determining a plurality of maximum available transmit powers available respectively for the plurality of OFDM symbols, and setting each of the plurality of maximum transmit powers to a lowest maximum available transmit power out of the plurality of maximum available transmit powers.

In some aspects, where the plurality of SRSs are for a codebook-based PUSCH transmission with a partial coherent precoder, the plurality of maximum transmit powers are determined by determining a plurality of maximum available transmit powers available respectively for the plurality of OFDM symbols, identifying two or more subsets of the plurality of OFDM symbols, each subset of the two or more subsets including one or more OFDM symbols of the plurality of OFDM symbols, wherein all SRS ports within each subset are coherent with each other, determining two or more lowest maximum available transmit powers respectively corresponding to the two or more subsets of the plurality of OFDM symbols, each of the two or more lowest maximum available transmit powers being determined based on a lowest maximum available transmit power out of maximum available transmit power within a respective subset of the two or more subset, and setting each of the two or more lowest maximum available transmit powers to one or more OFDM symbols of the plurality of OFDM symbols within a respective subset of the two or more subset.

At block 1910, the network entity may estimate a plurality of uplink channel qualities respectively associated with the plurality of SRS ports based on the plurality of SRSs. For example, the channel estimation circuitry 1744 shown and described above in connection with FIG. 17 may provide means for estimating the plurality of uplink channel qualities.

In one configuration, the network entity 1700 for wireless communication includes means for providing an SRS configuration to a UE, the SRS configuration indicating a plurality of SRS ports of an SRS resource assigned to a plurality of OFDM symbols, wherein a plurality of maximum transmit powers are respectively associated with the plurality of OFDM symbols, and wherein each of the plurality of maximum transmit powers is associated with a respective OFDM symbol of the plurality of OFDM symbols and is less than or equal to an maximum data transmit power available for transmitting uplink data using the plurality of SRS ports simultaneously; means for obtaining, from the UE, a plurality of SRSs respectively via the plurality of SRS ports in the plurality of OFDM symbols, wherein in each OFDM symbol, one or more SRSs of the plurality of SRSs are obtained respectively via one or more SRS ports of the plurality of SRS ports assigned to a respective OFDM symbol of the plurality of OFDM symbols, the one or more SRSs being obtained using a respective maximum transmit power of the plurality of maximum transmit powers that is associated with the respective OFDM symbol; and means for estimating a plurality of uplink channel qualities respectively associated with the plurality of SRS ports based on the plurality of SRSs. In some aspects, the network entity 1700 may further include means for obtaining, from the UE, a capability report indicating at least one of: the plurality of maximum transmit powers, or a plurality of power offsets, the plurality of power offsets indicating respective differences between the plurality of maximum transmit powers and the maximum data transmit power. In some aspects, the network entity 1700 may further include means for obtaining, from the UE, a power headroom report indicating at least one of: the plurality of maximum transmit powers, or a plurality of power offsets, the plurality of power offsets indicating respective differences between the plurality of maximum transmit powers and the maximum data transmit power.

In one aspect, the aforementioned means may be the processor(s) 1704 shown in FIG. 17 configured to perform the functions recited by the aforementioned means. In another aspect, the aforementioned means may be a circuit or any apparatus configured to perform the functions recited by the aforementioned means.

Of course, in the above examples, the circuitry included in the processor 704 is merely provided as an example, and other means for carrying out the described functions may be included within various aspects of the present disclosure, including but not limited to the instructions stored in the computer-readable storage medium 706, or any other suitable apparatus or means described in any one of the FIGS. 1, 2, and/or 3, and utilizing, for example, the processes and/or algorithms described herein in relation to FIGS. 9 and/or 10.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-19 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1, 2, 4, 8, 14, and/or 17 may be configured to perform one or more of the methods, features, or steps described herein. The novel algorithms described herein may also be efficiently implemented in software and/or embedded in hardware.

The following provides an overview of several aspects of the present disclosure.

Aspect 1: A method of wireless communication by a user equipment (UE), comprising: receiving a sounding reference signal (SRS) configuration from a network entity, the SRS configuration indicating a plurality of SRS ports of an SRS resource assigned to a plurality of symbols; determining a port transmit power for each of the plurality of SRS ports based on a total transmit power available for each of the plurality of symbols divided by a number of the SRS ports assigned in each of the plurality of symbols; and transmitting, to the network entity, a plurality of SRSs respectively via the plurality of SRS ports, wherein each SRS of the plurality of SRSs is transmitted using the port transmit power via a respective SRS port of the plurality of SRS ports in a respective symbol of the plurality of symbols.

Aspect 2: The method of aspect 1, wherein the plurality of symbols are a plurality of orthogonal frequency division multiplexing (OFDM) symbols.

Aspect 3: The method of aspect 1 or 2, wherein each symbol of the plurality of symbols is assigned a same number of SRS ports.

Aspect 4: The method of aspect 1 through 3, wherein the plurality of SRSs are for a codebook based physical uplink shared channel (PUSCH) or for an antenna switching for downlink channel state information (CSI) estimation.

Aspect 5: The method of any of aspects 1 through 4, wherein the total transmit power is derived based on an SRS power control loop driven by SRS power control commands indicated by the network entity.

Aspect 6: The method of any of aspects 1 through 5, further comprising:
transmitting, to the network entity, at least one of a capability report or a power headroom report indicating the total transmit power available for each OFDM symbol.

Aspect 7: The method of any of aspects 1 through 6, further comprising: receiving, from the network entity, a notification of a selected SRS port out of the plurality of SRS ports; and transmitting an uplink communication using the selected SRS port.

Aspect 8: The method of any of aspects 1 through 7, wherein the plurality of SRSs are transmitted on an active uplink bandwidth part of a carrier of a serving cell.

Aspect 9: An apparatus for wireless communication at a user equipment (UE), the apparatus comprising: one or more memories; and one or more processors coupled to the one or more memories, the one or more processors being configured to perform any one of aspects 1 through 8.

Aspect 10: A UE configured for wireless communication comprising at least one means for performing any one of aspects 1 through 8.

Aspect 11: A non-transitory computer-readable medium having stored therein instructions executable by one or more processors of a user equipment (UE) to cause the UE to perform any one of aspects 1 through 8.

Aspect 12: A method of wireless communication by a user equipment (UE), comprising: receiving a sounding reference signal (SRS) configuration from a network entity, the SRS configuration indicating a plurality of SRS ports of an SRS resource assigned to a plurality of orthogonal frequency division multiplexing (OFDM) symbols; determining a plurality of maximum transmit powers respectively associated with the plurality of OFDM symbols, each of the plurality of maximum transmit powers being associated with a respective OFDM symbol of the plurality of OFDM symbol and being less than or equal to an maximum data transmit power available for transmitting uplink data using the plurality of SRS ports simultaneously; and transmitting, to the network entity, a plurality of sounding reference signals (SRSs) respectively via the plurality of SRS ports in the plurality of OFDM symbols, wherein in each OFDM symbol, one or more SRSs of the plurality of SRSs are transmitted respectively via one or more ports of the plurality of SRS ports assigned to a respective OFDM symbol of the plurality of OFDM symbols, the one or more SRSs being transmitted using a respective maximum transmit power of the plurality of maximum transmit powers that is associated with the respective OFDM symbol.

Aspect 13: The method of aspect 12, wherein each OFDM symbol of the plurality of OFDM symbols is assigned a same number of SRS ports.

Aspect 14: The method of aspect 12 or 13, wherein the plurality of SRS ports are capable of transmitting respectively at a plurality of maximum port transmit powers, and wherein each of the plurality of maximum transmit powers for each OFDM symbol is based on one or more maximum port transmit powers respectively associated with the one or more ports assigned to the respective OFDM symbol.

Aspect 15: The method of any of aspects 12 through 14, wherein each of the plurality of maximum transmit powers has a same maximum transmit power value for each of the plurality of OFDM symbols.

Aspect 16: The method of aspect 15, wherein each of the plurality of SRS ports is capable of transmitting at a same maximum port transmit power, and wherein the same maximum transmit power value for each of the plurality of OFDM symbols is based on one or more maximum port transmit powers respectively associated with the one or more ports assigned to the respective OFDM symbol.

Aspect 17: The method of any of aspects 12 through 14, wherein the plurality of SRSs are for a noncodebook-based physical uplink shared channel (PUSCH) transmission and/or for a codebook-based PUSCH transmission with a non-coherent precoder, and wherein at least one of the plurality of maximum transmit powers is different from another one of the plurality of maximum transmit powers.

Aspect 18: The method of any of aspects 12 through 14, wherein the plurality of SRSs are for a codebook-based PUSCH transmission with a coherent precoder and/or for antenna switching for downlink channel state information (CSI), and wherein the determining the plurality of maximum transmit powers comprises: determining a plurality of maximum available transmit powers available respectively for the plurality of OFDM symbols; and setting each of the plurality of maximum transmit powers to a lowest maximum available transmit power out of the plurality of maximum available transmit powers.

Aspect 19: The method of any of aspects 12 through 14, wherein the plurality of SRSs are for a codebook-based PUSCH transmission with a partial coherent precoder, and wherein the determining the plurality of maximum transmit powers comprises: determining a plurality of maximum available transmit powers available respectively for the plurality of OFDM symbols; identifying two or more subsets of the plurality of OFDM symbols, each subset of the two or more subsets including one or more OFDM symbols of the plurality of OFDM symbols, wherein all SRS ports within each subset are coherent with each other; determining two or more lowest maximum available transmit powers respectively corresponding to the two or more subsets of the plurality of OFDM symbols, each of the two or more lowest maximum available transmit powers being determined based on a lowest maximum available transmit power out of maximum available transmit power within a respective subset of the two or more subset; and setting each of the two or more lowest maximum available transmit powers to one or more OFDM symbols of the plurality of OFDM symbols within a respective subset of the two or more subset.

Aspect 20: The method of any of aspects 12 through 19, further comprising: transmitting, to the network entity, a capability report indicating at least one of: the plurality of maximum transmit powers, or a plurality of power offsets, the plurality of power offsets indicating respective differences between the plurality of maximum transmit powers and the maximum data transmit power.

Aspect 21: The method of any of aspects 12 through 20, further comprising: transmitting, to the network entity, a power headroom report indicating at least one of: the plurality of maximum transmit powers, or a plurality of power offsets, the plurality of power offsets indicating respective differences between the plurality of maximum transmit powers and the maximum data transmit power.

Aspect 22: An apparatus for wireless communication at a user equipment (UE), the apparatus comprising: one or more memories; and one or more processors coupled to the one or more memories, the one or more processors being configured to perform any one of aspects 12 through 21

Aspect 23: A UE configured for wireless communication comprising at least one means for performing any one of aspects 12 through 21.

Aspect 24: A non-transitory computer-readable medium having stored therein instructions executable by one or more processors of a user equipment (UE) to cause the UE to perform any one of aspects 12 through 21.

Aspect 25: A method of wireless communication by a network entity, comprising: providing a sounding reference signal (SRS) configuration to a user equipment (UE), the SRS configuration indicating a plurality of SRS ports of an SRS resource assigned to a plurality of symbols, wherein a port transmit power for each of the plurality of SRS ports is based on a total transmit power divided by a number of the SRS ports assigned in each of the plurality of symbols; obtaining, from the UE, a plurality of SRSs respectively via the plurality of SRS ports, wherein each SRS of the plurality of SRSs is obtained via a respective SRS port of the plurality of SRS ports in a respective symbol of the plurality of symbols using the port transmit power; and estimating a plurality of uplink channel qualities respectively associated with the plurality of SRS ports based on the plurality of SRSs.

Aspect 26: The method of aspect 25, wherein the plurality of symbols are a plurality of orthogonal frequency division multiplexing (OFDM) symbols.

Aspect 27: The method of aspect 25 or 26, wherein each symbol of the plurality of symbols is assigned a same number of SRS ports.

Aspect 28: The method of any of aspects 25 through 27, wherein the plurality of SRSs are for a codebook based physical uplink shared channel (PUSCH) or for an antenna switching for downlink channel state information (CSI) estimation.

Aspect 29: The method of any of aspects 25 through 28, wherein the total transmit power is derived based on an SRS power control loop driven by SRS power control commands indicated by the network entity.

Aspect 30: The method of any of aspects 25 through 29, further comprising: obtaining, from the UE, at least one of a capability report or a power headroom report indicating the total transmit power available for each symbol.

Aspect 31: The method of any of aspects 25 through 30, further comprising: selecting an SRS port out of the plurality of SRS ports based on the plurality of uplink channel qualities; providing a notification of the selected SRS port to the UE; and obtaining an uplink communication from the UE using the selected SRS port.

Aspect 32: The method of any of aspects 25 through 31, wherein the plurality of SRSs are obtained on an active uplink bandwidth part of a carrier of a serving cell.

Aspect 33: An apparatus for wireless communication at a network entity, the apparatus comprising: one or more memories; and one or more processors coupled to the one or more memories, the one or more processors being configured to perform any one of aspects 25 through 32

Aspect 34: A network entity configured for wireless communication comprising at least one means for performing any one of aspects 25 through 32.

Aspect 35: A non-transitory computer-readable medium having stored therein instructions executable by one or more processors of a network entity to cause the network entity to perform any one of aspects 25 through 32.

Aspect 36: A method of wireless communication by a network entity, comprising: providing a sounding reference signal (SRS) configuration to a user equipment (UE), the SRS configuration indicating a plurality of SRS ports of an SRS resource assigned to a plurality of orthogonal frequency division multiplexing (OFDM) symbols, wherein a plurality of maximum transmit powers are respectively associated with the plurality of OFDM symbols, and wherein each of the plurality of maximum transmit powers is associated with a respective OFDM symbol of the plurality of OFDM symbols and is less than or equal to an maximum data transmit power available for providing uplink data using the plurality of SRS ports simultaneously; obtaining, from the UE, a plurality of SRSs respectively via the plurality of SRS ports in the plurality of OFDM symbols, wherein in each OFDM symbol, one or more SRSs of the plurality of SRSs are obtained respectively via one or more SRS ports of the plurality of SRS ports assigned to a respective OFDM symbol of the plurality of OFDM symbols, the one or more SRSs being obtained using a respective maximum transmit power of the plurality of maximum transmit powers that is associated with the respective OFDM symbol; and estimating a plurality of uplink channel qualities respectively associated with the plurality of SRS ports based on the plurality of SRSs.

Aspect 37: The method of aspect 36, wherein each OFDM symbol of the plurality of OFDM symbols is assigned a same number of SRS ports.

Aspect 38: The method of aspect 36 or 37, wherein the plurality of SRS ports are capable of transmitting respectively at a plurality of maximum port transmit powers, and wherein each of the plurality of maximum transmit powers is based on one or more maximum port transmit powers respectively associated with the one or more SRS ports assigned to the respective OFDM symbol.

Aspect 39: The method of any of aspects 36 through 38, wherein each of the plurality of maximum transmit powers has a same maximum transmit power value for each of the plurality of OFDM symbols.

Aspect 40: The method of aspect 33, wherein each of the plurality of SRS ports is capable of transmitting at a same maximum port transmit power, and wherein the same maximum transmit power value for each of the plurality of OFDM symbols is based on one or more maximum port transmit powers respectively associated with the one or more SRS ports assigned to the respective OFDM symbol.

Aspect 41: The method of any of aspects 36 through 38, wherein the plurality of SRSs are for a noncodebook-based physical uplink shared channel (PUSCH) transmission and/or for a codebook-based PUSCH transmission with a non-coherent precoder, and wherein at least one of the plurality of maximum transmit powers is different from another one of the plurality of maximum transmit powers.

Aspect 42: The method of any of aspects 36 through 38, wherein the plurality of SRSs are for a codebook-based PUSCH transmission with a coherent precoder and/or for antenna switching for downlink channel state information (CSI), and wherein the plurality of maximum transmit powers are determined by: determining a plurality of maximum available transmit powers available respectively for the plurality of OFDM symbols; and setting each of the plurality of maximum transmit powers to a lowest maximum available transmit power out of the plurality of maximum available transmit powers.

Aspect 43: The method of any of aspects 36 through 38, wherein the plurality of SRSs are for a codebook-based PUSCH transmission with a partial coherent precoder, and wherein the plurality of maximum transmit powers are determined by: determining a plurality of maximum available transmit powers available respectively for the plurality of OFDM symbols; identifying two or more subsets of the plurality of OFDM symbols, each subset of the two or more subsets including one or more OFDM symbols of the plurality of OFDM symbols, wherein all SRS ports within each subset are coherent with each other; determining two or more lowest maximum available transmit powers respectively corresponding to the two or more subsets of the plurality of OFDM symbols, each of the two or more lowest maximum available transmit powers being determined based on a lowest maximum available transmit power out of maximum available transmit power within a respective subset of the two or more subset; and setting each of the two or more lowest maximum available transmit powers to one or more OFDM symbols of the plurality of OFDM symbols within a respective subset of the two or more subset.

Aspect 44: The method of any of aspects 36 through 43, further comprising: obtaining, from the UE, a capability report indicating at least one of: the plurality of maximum transmit powers, or a plurality of power offsets, the plurality of power offsets indicating respective differences between the plurality of maximum transmit powers and the maximum data transmit power.

Aspect 45: The method of any of aspects 36 through 44, further comprising: obtaining, from the UE, a power headroom report indicating at least one of: the plurality of maximum transmit powers, or a plurality of power offsets, the plurality of power offsets indicating respective differences between the plurality of maximum transmit powers and the maximum data transmit power.

Aspect 46: An apparatus for wireless communication at a network entity, the apparatus comprising: one or more memories; and one or more processors coupled to the one or more memories, the one or more processors being configured to perform any one of aspects 36 through 45

Aspect 47: A network entity configured for wireless communication comprising at least one means for performing any one of aspects 36 through 45.

Aspect 48: A non-transitory computer-readable medium having stored therein instructions executable by one or more processors of a network entity to cause the network entity to perform any one of aspects 36 through 45.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112 (f) unless the element is expressly recited using the phrase “means for” or, in the case of a method claim, the element is recited using the phrase “step for.”

What is claimed is:

1. An apparatus for wireless communication at a user equipment (UE), the apparatus comprising:
one or more memories; and
one or more processors coupled to the one or more memories, the one or more processors being configured to:
receive a sounding reference signal (SRS) configuration from a network entity, the SRS configuration indicating a plurality of SRS ports of an SRS resource assigned to a plurality of symbols;
determine a port transmit power for each of the plurality of SRS ports based on a total transmit power available for each of the plurality of symbols divided by a number of the SRS ports assigned in each of the plurality of symbols; and
transmit, to the network entity, a plurality of SRSs respectively via the plurality of SRS ports, wherein each SRS of the plurality of SRSs is transmitted using the port transmit power via a respective SRS port of the plurality of SRS ports in a respective symbol of the plurality of symbols.

2. The apparatus of claim 1, wherein the plurality of symbols are a plurality of orthogonal frequency division multiplexing (OFDM) symbols.

3. The apparatus of claim 1, wherein each symbol of the plurality of symbols is assigned a same number of SRS ports.

4. The apparatus of claim 1, wherein the plurality of SRSs are for a codebook based physical uplink shared channel (PUSCH) or for an antenna switching for downlink channel state information (CSI) estimation.

5. The apparatus of claim 1, wherein the total transmit power is derived based on an SRS power control loop driven by SRS power control commands indicated by the network entity.

6. The apparatus of claim 1, wherein the one or more processors are further configured to:
transmit, to the network entity, at least one of a capability report or a power headroom report indicating the total transmit power available for each symbol.

7. The apparatus of claim 1, wherein the one or more processors are further configured to:
receive, from the network entity, a notification of a selected SRS port out of the plurality of SRS ports; and
transmit an uplink communication using the selected SRS port.

8. The apparatus of claim 1, wherein the plurality of SRSs are transmitted on an active uplink bandwidth part of a carrier of a serving cell.

9. A method of wireless communication by a user equipment (UE), comprising:
receiving a sounding reference signal (SRS) configuration from a network entity, the SRS configuration indicating a plurality of SRS ports of an SRS resource assigned to a plurality of symbols;
determining a port transmit power for each of the plurality of SRS ports based on a total transmit power available for each of the plurality of symbols divided by a number of the SRS ports assigned in each of the plurality of symbols; and
transmitting, to the network entity, a plurality of SRSs respectively via the plurality of SRS ports, wherein each SRS of the plurality of SRSs is transmitted using the port transmit power via a respective SRS port of the plurality of SRS ports in a respective symbol of the plurality of symbols.

10. The method of claim 9, wherein the plurality of symbols are a plurality of orthogonal frequency division multiplexing (OFDM) symbols.

11. The method of claim 9, wherein each symbol of the plurality of symbols is assigned a same number of SRS ports.

12. The method of claim 9, wherein the plurality of SRSs are for a codebook based physical uplink shared channel (PUSCH), for a non-codebook based PUSCH, or for an antenna switching for downlink channel state information (CSI) estimation.

13. The method of claim 9, wherein the total transmit power is derived based on an SRS power control loop driven by SRS power control commands indicated by the network entity.

14. The method of claim 9, further comprising:
transmitting, to the network entity, at least one of a capability report or a power headroom report indicating the total transmit power available for each symbol.

15. The method of claim 9, further comprising
receiving, from the network entity, a notification of a selected SRS port out of the plurality of SRS ports; and
transmitting an uplink communication using the selected SRS port.

16. An apparatus for wireless communication at a network entity, the apparatus comprising:
one or more memories; and
one or more processors coupled to the one or more memories, the one or more processors being configured to:
provide an SRS configuration to a user equipment (UE), the SRS configuration indicating a plurality of sounding reference signal (SRS) ports of an SRS resource assigned to a plurality of symbols, wherein a port transmit power for each of the plurality of SRS ports is based on a total transmit power divided by a number of the SRS ports assigned in each of the plurality of symbols;
obtain, from the UE, a plurality of SRSs respectively via the plurality of SRS ports, wherein each SRS of the plurality of SRSs is obtained via a respective SRS port of the plurality of SRS ports in a respective symbol of the plurality of symbols using the port transmit power; and
estimate a plurality of uplink channel qualities respectively associated with the plurality of SRS ports based on the plurality of SRSs.

17. The apparatus of claim 16, wherein the plurality of symbols are a plurality of orthogonal frequency division multiplexing (OFDM) symbols.

18. The apparatus of claim 16, wherein each symbol of the plurality of symbols is assigned a same number of SRS ports.

19. The apparatus of claim 16, wherein the plurality of SRSs are for a codebook based physical uplink shared channel (PUSCH) or for an antenna switching for downlink channel state information (CSI) estimation.

20. The apparatus of claim 16, wherein the total transmit power is derived based on an SRS power control loop driven by SRS power control commands indicated by the network entity.

21. The apparatus of claim 16, wherein the one or more processors are further configured to:
obtain, from the UE, at least one of a capability report or a power headroom report indicating the total transmit power available for each symbol.

22. The apparatus of claim 16, wherein the one or more processors are further configured to:
select an SRS port out of the plurality of SRS ports based on the plurality of uplink channel qualities;
provide a notification of the selected SRS port to the UE; and
obtain an uplink communication from the UE using the selected SRS port.

23. The apparatus of claim 16, wherein the plurality of SRSs are obtained on an active uplink bandwidth part of a carrier of a serving cell.

24. A method of wireless communication by a network entity, comprising:
providing a sounding reference signal (SRS) configuration to a user equipment (UE), the SRS configuration indicating a plurality of SRS ports of an SRS resource assigned to a plurality of symbols, wherein a port transmit power for each of the plurality of SRS ports is based on a total transmit power divided by a number of the SRS ports assigned in each of the plurality of symbols;
obtaining, from the UE, a plurality of SRSs respectively via the plurality of SRS ports, wherein each SRS of the plurality of SRSs is obtained via a respective SRS port of the plurality of SRS ports in a respective symbol of the plurality of symbols using the port transmit power; and
estimating a plurality of uplink channel qualities respectively associated with the plurality of SRS ports based on the plurality of SRSs.

25. The method of claim 24, wherein the plurality of symbols are a plurality of orthogonal frequency division multiplexing (OFDM) symbols.

26. The method of claim 24, wherein each symbol of the plurality of symbols is assigned a same number of SRS ports.

27. The method of claim 24, wherein the plurality of SRSs are for a codebook based physical uplink shared channel (PUSCH), for a non-codebook based PUSCH, or for an antenna switching for downlink channel state information (CSI) estimation.

28. The method of claim 24, wherein the total transmit power is derived based on an SRS power control loop driven by SRS power control commands indicated by the network entity.

29. The method of claim 24, further comprising:
obtaining, from the UE, at least one of a capability report or a power headroom report indicating the total transmit power available for each OFDM symbol.

30. The method of claim 24, further comprising:
selecting an SRS port out of the plurality of SRS ports based on the plurality of uplink channel qualities;
providing a notification of the selected SRS port to the UE; and
obtaining an uplink communication from the UE using the selected SRS port.
